(19) United States
(12) Patent Application Publication
(10) Pub. No.: US 2010/0127434 A1
(43) Pub. Date: May 27, 2010

(54) EXTRUDING ORGANIC POLYMERS

(76) Inventors: Rene Broos, Bornem (BE); Marlies C. Totte-van 'T Westeinde, Oostburg (NL)

Correspondence Address: The Dow Chemical Company, Intellectual Property Section, P.O. Box 1967, Midland, MI, 48641-1967, US

(21) Appl. No.: 12/623,347

(22) Filed: Nov. 20, 2009

Related U.S. Application Data
(60) Provisional application No. 61/117,796, filed on Nov. 25, 2008.

(51) Int. Cl. B29C 49/64; B29C 47/00; B29C 39/14; B29C 47/88; C08K 3/32; C08K 3/30; C08K 3/10; C08K 3/16

(52) U.S. Cl. 264/454; 264/211; 264/555; 264/465; 524/417; 524/423; 524/436; 524/401

(57) ABSTRACT

The instant invention generally provides a process for extruding a melt of a mixture comprising a molecularly self-assembling (MSA) material and at least one first rheological additive to give a shaped MSA material, a shaped MSA material produced by the process, and an article comprising the shaped MSA material. The instant invention also generally provides a composition comprising a MSA material and at least one second rheological additive, a process of electrospinning the composition, and a fiber prepared by the electrospinning process.

### CROSS-REFERENCE TO RELATED APPLICATION(S)

This application claims benefit of priority from U.S. Provisional Patent Application No. 61/117,796, filed Nov. 25, 2008, which application is incorporated by reference herein in its entirety.

The present invention is generally in the fields of organic polymers and extrusion.

### BACKGROUND OF THE INVENTION

Extrusion of a melt of an organic polymer is a versatile method of shaping the organic polymer. The method typically comprises pushing the melt through an orifice in a die or mold to give a shaped organic polymer. The orifice may be defined in the shape of, for example, a straight slit, circular slit, or round aperture. Where the orifice is defined in a mold, extrusion comprises injecting or casting the melt through the orifice into the mold to produce a shaped organic polymer as a molded or cast part. Where the orifice is the straight slit, circular slit, or round aperture in a die, extrusion comprises pushing the melt through and out of the straight slit, circular slit, or round aperture to respectively form a film or sheet, hose or tubing, or fiber.

Extrusion of conventional organic polymers employs high process pressures and temperatures, which typically are 200 degrees Celsius (° C.) or higher. Thermal degradation of the organic polymers and equipment design factors, however, frequently limit maximum process temperatures and pressures to values below those needed for optimal process performance.

To achieve attractive extruder production rates within such temperature and pressure limitations, skilled artisans usually lower the organic polymer's molecular weight. But extruding lower molecular weight organic polymers usually leads to shaped organic polymers having comparatively inferior physical and mechanical properties (e.g., fiber strength). Further, the presence of water in conventional organic polymer melts has heretofore caused defects (e.g., gas bubbles and fractures) in the shaped organic polymer. Consequently, skilled artisans in the extrusion art have either avoided using organic polymers “contaminated” with water (for present purposes, contamination means more than 0.5 weight percent of water based on total weight of the organic polymer) or have had to extrude a water-containing organic polymer at high temperature (greater than 100 degrees Celsius (° C.)) and employ a post-extrusion decompression unit. The decompression unit is under high pressure when it receives the high temperature, extruded, water-containing organic polymer from the extruder. The high pressure is sufficiently greater than standard atmospheric pressure of 101 kiloPascals (kPa) to keep the water from vaporizing from, and thereby generating defects such as gas bubbles, fractures, or both in, the extruded, water-containing organic polymer. The decompression unit then lets down the pressure as the extruded, water-containing organic polymer cools.

PCT International Patent Application Publication Number WO 2008/101051 describes melt electrospinning molecularly self-assembling (MSA) materials (e.g., copoly(ester amide), copoly(ester urethane), and copoly(ester urea) organic polymers) into fibers.

PCT International Patent Application Publication Number WO 2008/112834 describes adhesive MSA materials for forming laminate structures.

Zhang Y and P J Cremer, Interactions between macromolecules and ions: the Hofineister series, Current Opinion in Chemical Biology 2006, 10: 658-663, review experiments and theoretical models of interactions in water of ions in the Hofineister series and macromolecules.

Hardy J G, et al., Polymeric materials based on silk proteins, Polymer, 2008; 49:4309-4327, review features of silk proteins used by arthropods (i.e., silkworms and spiders) to make fibers and potential applications thereof.

U.S. Patent Application Publication Number US 2005/0067732 A1 describes a melt electroblowing apparatus and process.

There is a need in the art for improved methods of processing melts of organic polymers to give shaped products thereof.

### SUMMARY OF THE INVENTION

In a first embodiment, the instant invention is a process for extruding a molecularly self-assembling (MSA) material, the process comprising a step of extruding a melt of a first composition comprising a molecularly self-assembling material and a first rheological additive to produce a shaped MSA material, wherein the first rheological additive comprises a total of from 0.5 weight percent (wt %) to 10 wt % of the first composition, the extruding step excludes electrospinning, and the first rheological additive comprises an inorganic salt, an organic salt, water, an aqueous solution of an inorganic or organic salt, an aqueous solution of an inorganic acid, or an aqueous solution of an inorganic base. Preferably, the melt extruding step comprises melt spinning, melt blowing, or melt electroblowing. Also preferably, the process further comprises a step of removing at least 90% of the first rheological additive from the shaped MSA material, which removing step may be simultaneous with, subsequent to, or both the extruding step.

In a second embodiment, the instant invention is the shaped MSA material prepared by the process of the first embodiment. Preferably, the shaped MSA material is a film, sheet, fiber, hose, tubing, cast part, or molded part. More preferably, the shaped MSA material is a hose or tubing, still more preferably, a cast or molded part, even more preferably a film or sheet, and yet more preferably a fiber. The film includes a coating and an adhesive film.

In a third embodiment, the instant invention is an article comprising the shaped MSA material of the second embodiment. Preferably, the article is a bandage, medical gown, medical scaffold, cosmetic, sound insulation, barrier material, diaper coverstock, adult incontinence pants, training pants, underpad, feminine hygiene pad, wiping cloth, porous filter medium (e.g., for filtering air, gasses, or liquids), durable paper, fabric softener, home furnishing, floor covering backing, geotextile, apparel, apparel interfacing, apparel lining, shoe, industrial garment, agricultural fabric, automotive fabric, coating substrate, laminating substrate comprising a substrate layer and a sheet of MSA material, leather, or electronic component.

In a fourth embodiment, the instant invention is a second composition comprising a molecularly self-assembling material and a second rheological additive, wherein the second rheological additive comprises a total of from 0.5 weight percent (wt %) to 10 wt % of the second composition; and the second rheological additive comprises an inorganic salt, an organic salt, an aqueous solution of the inorganic or organic salt, an aqueous solution of an inorganic acid, or an aqueous solution of an inorganic base, wherein the inorganic salt comprises an anion that is fluoride (F⁻), sulfate (SO₄²⁻), hydrogen sulfate (HSO₄⁻), thiosulfate (S₂O₃²⁻), phosphate (PO₄³⁻), hydrogen phosphate (HPO₄²⁻), dihydrogen phosphate (H₂PO₄⁻), chloride (Cl⁻), nitrate (NO₃⁻), bromide (Br⁻), iodide (I⁻), or perchlorate (ClO₄⁻); a cation that is ammonium (NH₄⁺), potassium cation (K⁺), sodium cation (Na⁺), lithium cation (Li⁺), magnesium cation (Mg²⁺), or calcium cation (Ca²⁺); or at least one of the foregoing anions and at least one of the foregoing cations; and the organic salt has from 1 to 3 carbon atoms. The second composition of the fourth embodiment is especially useful in, and in some embodiments employed in, a process of the first embodiment.

In a fifth embodiment, the instant invention is a process for melt electrospinning a fiber comprising a MSA material, the process comprising steps of: feeding a melt of the second composition of the fourth embodiment into a melt electrospinning device; and applying a voltage to the device such that the second composition is drawn and a jet is formed to produce a fiber comprising the MSA material. Also preferably, the process further comprises a step of removing at least 90% of the second rheological additive from the shaped MSA material, which removing step may be simultaneous with, subsequent to, or both fiber-forming.

In a sixth embodiment, the instant invention is the fiber comprising a MSA material prepared by the process of the fifth embodiment.

Additional embodiments of the present invention are illustrated in the accompanying drawings and are described in the following detailed description and claims.

### BRIEF DESCRIPTION OF THE DRAWINGS

FIG. 1 depicts a Differential Scanning Calorimetry (DSC) trace of the MSA material of Preparation 1.

FIG. 2 depicts a plot of apparent viscosity versus shear rate of the materials of Preparation 2 and Examples 1 and 2.

FIGS. 3a and 3b depict overlayed first and second heating DSC traces, respectively, of the material of Example 2 and compositions of Examples 4 and 5.

### DETAILED DESCRIPTION OF THE INVENTION

As used herein, “a,” “an,” “the,” “at least one,” and “one or more” are used interchangeably. In any embodiment of the instant invention described herein, the open-ended terms “comprising,” “comprises,” and the like (which are synonymous with “including,” “having,” and “characterized by”) may be replaced by the respective partially closed phrases “consisting essentially of,” “consists essentially of,” and the like or the respective closed phrases “consisting of,” “consists of,” and the like. In the present application, when referring to a preceding list of elements (e.g., ingredients), the phrases “mixture thereof,” “combination thereof,” and the like mean any two or more, including all, of the listed elements.

For purposes of United States patent practice and other patent practices allowing incorporation of subject matter by reference, the entire contents—unless otherwise indicated—of each U.S. patent, U.S. patent application, U.S. patent application publication, PCT international patent application and WO publication equivalent thereof, referenced in the instant Detailed Description of the Invention are hereby incorporated by reference. In an event where there is a conflict between what is written in the present specification and what is written in a patent, patent application, or patent application publication, or a portion thereof that is incorporated by reference, what is written in the present specification controls. The present specification may be subsequently amended to incorporate by reference subject matter from a U.S. patent or U.S. patent application publication, or portion thereof, instead of from a PCT international patent application or WO publication equivalent, or portion thereof, originally referenced herein, provided that no new matter is added and the U.S. patent or U.S. patent application publication claims priority directly from the PCT international patent application.

In the present application, headings (e.g., “Definitions”) are used for convenience and are not meant, and should not be used, to limit scope of the present disclosure in any way.

In the present application, any lower limit of a range of numbers, or any preferred lower limit of the range, may be combined with any upper limit of the range, or any preferred upper limit of the range, to define a preferred embodiment of the range. Each range of numbers includes all numbers subsumed within that range (e.g., the range from about 1 to about 5 includes, for example, 1, 1.5, 2, 2.75, 3, 3.80, 4, and 5).

In an event where there is a conflict between a unit value that is recited without parentheses, e.g., 2 inches, and a corresponding unit value that is parenthetically recited, e.g., (5 centimeters), the unit value recited without parentheses controls.

### DEFINITIONS

As used herein, the term “electrospinning” means employing an electrical charge to draw a fiber from a liquid (e.g., a melt or a solution), wherein the fiber has an average diameter of 30 micrometers (μm) of less.

The term “extrusion” means pushing a melt comprising an extrudable material through an orifice defined in a block (e.g., a die or mold) of an extruder to give a shaped material. Preferably, the melt extrusion comprises melt spinning, melt blowing, and melt electroblowing, but not electrospinning In some embodiments, extrusion comprises melt spinning, i.e., extrusion without assistance of a hot gas (e.g., as in melt blowing), applied voltage (e.g., as in melt electroblowing), or both.

The term “extrusion temperature” means degree of hotness or coldness of the melt where the melt exits the orifice defined in the block of the extruder (e.g., a melt spinning, melt blowing, or melt electroblowing device).

The terms “molded part” and “cast part” include whole articles sold in commerce and parts thereof.

The term “rheological additive” means a substance that is capable of modulating elasticity, zero shear viscosity, or both of a MSA material when the substance is essentially evenly dispersed in the MSA material in the from 1 wt % to 10 wt % amount employed in the first embodiment. For present purposes, the zero shear viscosity is determined using a Brookfield DV-II+Vicosimeter with spindle number 28 at 20 revolutions per minute (rpm). For present purposes, the elasticity means ultimate tensile strength and is determined according to the procedure described below in the Examples. The term “T_{g}” means glass transition temperature as determined by differential scanning calorimetry (DSC).

The term “Tₘ” means melting temperature as determined by DSC. If a MSA material has one or more Tₘ, preferably at least one Tₘ is 25° C. or higher.

For purposes herein, determine T_{g} and Tₘ according to the following procedure. Load a sample weighing between 5 milligrams (mg) and 10 mg into an aluminum hermetic DSC pan. Sequentially expose the sample to a first heating scan, holding step, cooling step, and a second heating scan. Particularly, in the first heating scan, heat the sample to 200° C. at a heating rate of 10° C. per minute. Hold the sample at 200° C. for 1 minute, and then cool the sample to −80° C. at a cooling rate of 10° C. per minute. Then in the second heating scan, heat the cooled sample to 200° C. at a heating rate of 10° C. per minute. Determine thermal events such as T_{g} and Tₘ from the second heating scan.

Preferably the melt of the invention composition is characterized as having a viscosity that is less than a viscosity of a melt consisting essentially of the molecularly self-assembling material, wherein each viscosity is determined at a same temperature. More preferably, the same temperature is the higher of 10° C. above (a highest) glass transition temperature (T_{g}) or above melting temperature (Tₘ) of the molecularly self-assembling material, still more preferably at 130° C., still more preferably at 95° C. Also preferably, the viscosity of the melt of the composition is more than 5 percent (%) lower, more preferably more than 10% lower, still more preferably more than 20% lower than the viscosity of the melt consisting essentially of the molecularly self-assembling material.

### Rheological Additives

In some embodiments, the rheological additive is water (i.e., H₂O), preferably essentially water (i.e., at least 90 wt % water, more preferably at least 95 wt % water, and still more preferably at least 99% water compared to the total weight of the rheological additive). Also preferably, the water useful as the rheological additive, or water used to prepare the aqueous solution of an inorganic or organic salt or the aqueous solution of an inorganic acid or inorganic base, is essentially pure (i.e., greater than 95% water, more preferably greater than 99% water). Examples of essentially pure water are deionized water, reverse osmosis-treated water, filtered water, and distilled water. More preferably, the water is pure and may be characterized as having a pH of about 7, still more preferably about 7.0.

In other embodiments, the rheological additive is an inorganic salt. The inorganic salts are ionic compounds that lack carbon atoms. The ionic compounds preferably consist of inorganic cations and inorganic anions. In some embodiments, the inorganic cations and anions are independently selected according to a Hofineister series classification of ions. A preferred inorganic anion is fluoride (F⁻), sulfate (SO₄²⁻), hydrogen sulfate (HSO₄⁻), thiosulfate (S₂O₃²⁻), phosphate (PO₄³⁻), hydrogen phosphate (HPO₄²⁻), dihydrogen phosphate (H₂PO₄⁻), chloride (Cl⁻), nitrate (NO₃⁻), bromide (Br⁻), iodide (I⁻), or perchlorate (ClO₄⁻). A preferred inorganic cation is ammonium (NH₄⁺), potassium cation (K⁺), sodium cation (Na⁺), lithium cation (Li⁺), magnesium cation (Mg²⁺), or calcium cation (Ca²⁺). A preferred inorganic salt consists of the preferred inorganic cation and inorganic anion, which are selected so that the inorganic salt is neutral overall. A more preferred inorganic salt is Mg(NO₃)₂ or (NH₄)₂SO₄.

In other embodiments, the rheological additive is an organic salt. The organic salt is an ionic compound that contains at least one carbon atom. Preferably, the organic salt contains not more than four, more preferably not more than three, and still more preferably not more than two carbon atoms. Even more preferably, the organic salt contains only one carbon atom. The ionic compounds preferably consist of organic cations, organic anions, or both. In some embodiments, the organic salt comprises an organic cation, preferably tetramethylammonium (N(CH₃)₄⁺) or guanidinium (C(NH₂)₃⁺). In other embodiments, the organic salt comprises an organic anion, preferably carbonate (CO₃²⁻), acetate (CH₃CO₂⁻), or thiocyanate (SCN⁻).

In still other embodiments, the rheological additive is an aqueous solution of an inorganic or organic salt. The inorganic or organic salt comprising the aqueous solution is as described above. In some embodiments, the aqueous solution of an inorganic or organic salt is characterized as being neutral, acidic or basic, i.e., as having any pH, although preferably the pH is from pH 1 to pH 14. In more preferred embodiments, the aqueous solution of an inorganic or organic salt is neutral, i.e., its pH is about pH 7, still more preferably about pH 7.0. In other preferred embodiments, aqueous solution of an inorganic or organic salt is acidic or basic, i.e., the pH of the aqueous solution of an inorganic or organic salt is respectively from pH 1 to less than pH 7 or from greater than pH 7 to pH 14. More preferably, the pH is at least about pH 2, still more preferably at least about pH 3, and even more preferably at least about pH 3. Also more preferably, the pH is about pH 13 or less, still more preferably about pH 12 or less, and even more preferably about pH 11 or less. The pH of the aqueous solution of an inorganic or organic salt will depend upon factors such as the particular inorganic or organic salt employed, the concentration of the solution, and the presence or absence of further components such as an inorganic acid or base. In some embodiments, the aqueous solution of an inorganic or organic salt further comprises a pH-modulating amount of an inorganic acid or inorganic base as a means of adjusting the pH to a respective desirable value.

In still other embodiments, the rheological additive is an aqueous solution of an inorganic acid or inorganic base. The aqueous solution of the inorganic acid may be characterized as having any pH below pH 7, although preferably the pH is from pH 1 to less than pH 7.0. The aqueous solution of the inorganic base may be characterized as having any pH above pH 7, although preferably the pH is from greater than pH 7.0 to pH 14. Suitable inorganic acids and bases include inorganic Lewis acids and bases and inorganic Brøntsted-Lowry acids and bases. Preferably, the inorganic Brøntsted-Lowry acids and bases are respective conjugate acids and bases of the inorganic anions or inorganic cations comprising the inorganic salts. More preferably, the inorganic Brøntsted-Lowry acid is hydrogen chloride (HCl), sulfuric acid (H₂SO₄), thiosulfuric acid (H₂SO₃), phosphoric acid (H₃PO₄), nitric acid (HNO₃), hydrogen bromide, perchloric acid (HClO₄), thiocyanic acid (HSCN), or a NH₄⁺ salt of any one of the aforementioned inorganic Brøntsted-Lowry acids. Also more preferably, the inorganic Brøntsted-Lowry base is ammonium hydroxide (NH₄OH), a metal hydroxide or metal oxide, wherein the metal preferably is K⁺, Na⁺, Li⁺, Mg²⁺, or Ca²⁺. Also preferably, the Lewis acid comprises a metal halide (e.g., aluminum(III), iron(II), iron(III), or boron(III) fluoride, chloride, bromide or iodide), still more preferably a metal chloride, even more preferably AlCl₃, FeCl₃, or BCl₃. Also preferably, the Lewis base comprises ammonia (NH₃).

In some embodiments, there is only one rheological additive. In other embodiments, there independently are two or more rheological additives. In such other embodiments, preferably there are 10 or fewer, more preferably 5 or fewer, still more preferably 3 or fewer, and even more preferably only 2 rheological additives.

In some embodiments, the rheological additive has a molecular weight of 190 grams per mole (g/mol) or less, more preferably 150 g/mol or less, still more preferably 120 g/mol or less, and even more preferably 100 g/mol or less.

Preferably, the rheological additive is at least capable of modulating zero shear viscosity of the MSA material. More preferably, the rheological additive is at least capable of reducing zero shear viscosity of the MSA material by at least 10%, still more preferably at least 20%, and even more preferably at least 30% compared to the zero shear viscosity of the MSA material itself (i.e., without the rheological additive).

Preferably, the rheological additive, or combination two or more rheological additives, comprises a total of at least about 1 weight percent (wt %), more preferably at least about 2 wt %, still more preferably at least about 3 wt %, and even more preferably at least about 4 wt % of the composition. Also preferably, the rheological additive comprises a total of about 8 wt % or less, more preferably about 7 wt % or less, still more preferably about 6 wt % or less, and even more preferably about 5 wt % or less of the composition. In some embodiments wherein the rheological additive comprises water, the rheological additive comprises a total of from 2.5 wt % to 7.5 wt %, more preferably from 4 wt % to 6 wt %, and still more preferably about 5 wt % of the composition. In other embodiments wherein the rheological additive consists essentially of an inorganic salt, the rheological additive comprises a total of from about 0.5 wt % to about 3 wt %, more preferably from about 0.75 wt % to about 2.5 wt %, and still more preferably from about 1.0 wt % to about 2.0 wt %.

In some embodiments, the rheological additive is a substance that (a) reduces viscosity of a melt of a composition comprising a MSA material and the substance compared to viscosity of the MSA material alone (i.e., lacking the substance), (b) allows extrusion of smaller average diameter fibers from a melt of a composition comprising the substance and the MSA material compared to average diameter of fibers extruded under essentially equivalent processing conditions from a melt of the MSA material lacking the substance, (c) allows 10% or higher production rates from extruding shaped MSA materials with the substance compared to production rates under essentially equivalent processing conditions from extruding shaped MSA materials lacking the substance (e.g., as measured by weights of shaped MSA materials produced per unit of time), (d) allows production of a shaped MSA material from a melt of a composition comprising the substance and the MSA material at lower temperatures compared to temperatures of a melt of the MSA material lacking the substance, (e) reduces surface tension of the melt, or (f) a combination of any two or more of (a) to (e).

In some embodiments, the rheological additive is an inorganic or organic salt comprising an anion or cation, preferably both, that is characterized as kosmotropic or chaotropic. Typically, the more negative is Gibbs energy (also known as Gibbs function or Gibbs free energy) of hydration (ΔGhydr) of the inorganic or organic salt, the more kosmotropic is the inorganic or organic salt. Preferably, kosmotropic anions and cations and chaotropic anions and cations independently are identified according to the Hofineister series of ions. Preferred kosmotropic anions are acetate, more preferably hydrogen phosphate (HPO₄²⁻), and still more preferably sulfate (SO₄²⁻). Preferred kosmotropic cations are Li⁺, more preferably Na⁺, still more preferably K⁺, and even more preferably NH₄⁺. Preferred chaotropic anions are NO₃⁻, more preferably I⁻, still more preferably ClO₄⁻, and even more preferably SCN⁻. Preferred chaotropic cations are Mg²⁺, more preferably Ca²⁺, and still more preferably guanidinium. In some embodiments, the rheological additive comprises a chaotropic anion, cation, or both that decreases viscosity of the melt of a composition comprising a MSA material and the rheological additive compared to viscosity of a melt consisting of the MSA material without the rheological additive. In other embodiments, the rheological additive comprises a kosmotropic anion, cation, or both that increases viscosity of the melt of a composition comprising a MSA material and the rheological additive compared to viscosity of a melt consisting of the MSA material without the rheological additive.

Preferably, pH is measured using a commercially available pH meter such as, for example, the hand-held OAKTON™ (Cole-Parmer Instrument Company) pH/mV/Temperature Basic pH 11 meter, which is available from Cole-Parmer Instrument Company, Vernon Hills, Ill., USA.

Preferably, the inorganic acids, inorganic bases, and inorganic or organic salts are obtained from any one of numerous commercial sources such as, for example, the Sigma-Aldrich Company (Saint Louis, Mo., USA). In some embodiments, an inorganic acid and an inorganic base are mixed together in water to make the neutral, acidic, or basic aqueous solution of an inorganic or organic salt.

### Molecularly Self-Assembling Material

As used herein, a MSA material useful in the present invention means an oligomer or polymer that effectively forms larger associated or assembled oligomers and/or polymers through the physical intermolecular associations of chemical functional groups. Without wishing to be bound by theory, it is believed that the intermolecular associations do not increase the molecular weight (Mn-Number Average molecular weight) or chain length of the self-assembling material and covalent bonds between said materials do not form. This combining or assembling occurs spontaneously upon a triggering event such as cooling to form the larger associated or assembled oligomer or polymer structures. Examples of other triggering events are the shear-induced crystallizing of, and contacting a nucleating agent to, a molecularly self-assembling material. Accordingly, in preferred embodiments MSAs exhibit mechanical properties similar to some higher molecular weight synthetic polymers and viscosities like very low molecular weight compounds. MSA organization (self-assembly) is caused by non-covalent bonding interactions, often directional, between molecular functional groups or moieties located on individual molecular (i.e. oligomer or polymer) repeat units (e.g. hydrogen-bonded arrays). Non-covalent bonding interactions include: electrostatic interactions (ion-ion, ion-dipole or dipole-dipole), coordinative metal-ligand bonding, hydrogen bonding, π-π-structure stacking interactions, donor-acceptor, and/or van der Waals forces and can occur intra- and intermolecularly to impart structural order. One preferred mode of self-assembly is hydrogen-bonding and this non-covalent bonding interactions is defined by a mathematical “Association constant”, K(assoc) constant describing the relative energetic interaction strength of a chemical complex or group of complexes having multiple hydrogen bonds. Such complexes give rise to the higher-ordered structures in a mass of MSA materials. A description of self assembling multiple H-bonding arrays can be found in “Supramolecular Polymers”, Alberto Ciferri Ed., 2nd Edition, pages (pp) 157-158. A “hydrogen bonding array” is a purposely synthesized set (or group) of chemical moieties (e.g. carbonyl, amine, amide, hydroxyl. etc.) covalently bonded on repeating structures or units to prepare a self assembling molecule so that the individual chemical moieties preferably form self assembling donor-acceptor pairs with other donors and acceptors on the same, or different, molecule. A “hydrogen bonded complex” is a chemical complex formed between hydrogen bonding arrays. Hydrogen bonded arrays can have association constants K (assoc) between 10² and 10⁹ M⁻¹ (reciprocal molarities), generally greater than 10³ M⁻¹. In preferred embodiments, the arrays are chemically the same or different and form complexes.

Accordingly, the molecularly self-assembling materials (MSA) presently include: molecularly self-assembling polyesteramides, copolyesteramide, copolyetheramide, copolyetherester-amide, copolyetherester-urethane, copolyether-urethane, copolyester-urethane, copolyester-urea, copolyetherester-urea and their mixtures. Preferred MSA include copolyesteramide, copolyether-amide, copolyester-urethane, and copolyether-urethanes. The MSA preferably has number average molecular weights, MWₙ (interchangeably referred to as Mₙ) (as is preferably determined by NMR spectroscopy) of 2000 grams per mole or more, more preferably at least about 3000 g/mol, and even more preferably at least about 5000 g/mol. The MSA preferably has MWₙ 50,000 g/mol or less, more preferably about 20,000 g/mol or less, yet more preferably about 15,000 g/mol or less, and even more preferably about 12,000 g/mol or less. The MSA material preferably comprises molecularly self-assembling repeat units, more preferably comprising (multiple) hydrogen bonding arrays, wherein the arrays have an association constant K (assoc) preferably from 10² to 10⁹ reciprocal molarity (M⁻¹) and still more preferably greater than 10³ M⁻¹; association of multiple-hydrogen-bonding arrays comprising donor-acceptor hydrogen bonding moieties is the preferred mode of self assembly. The multiple H-bonding arrays preferably comprise an average of 2 to 8, more preferably 4-6, and still more preferably at least 4 donor-acceptor hydrogen bonding moieties per molecularly self-assembling unit. Molecularly self-assembling units in preferred MSA materials include bis-amide groups, and bis-urethane group repeat units and their higher oligomers.

Preferred self-assembling units in the MSA material useful in the present invention are bis-amides, bis-urethanes and bis-urea units or their higher oligomers. A more preferred self-assembling unit comprises a poly(ester-amide), poly(ether-amide), poly(ester-urea), poly(ether-urea), poly(ester-urethane), or poly(ether-urethane), or a mixture thereof. For convenience and unless stated otherwise, oligomers or polymers comprising the MSA materials may simply be referred to herein as polymers, which includes homopolymers and interpolymers such as co-polymers, terpolymers, etc.

In some embodiments, the MSA materials include “non-aromatic hydrocarbylene groups” and this term means specifically herein hydrocarbylene groups (a divalent radical formed by removing two hydrogen atoms from a hydrocarbon) not having or including any aromatic structures such as aromatic rings (e.g. phenyl) in the backbone of the oligomer or polymer repeating units. In some embodiments, non-aromatic hydrocarbylene groups are optionally substituted with various substituents, or functional groups, including but not limited to: halides, alkoxy groups, hydroxy groups, thiol groups, ester groups, ketone groups, carboxylic acid groups, amines, and amides. A “non-aromatic heterohydrocarbylene” is a hydrocarbylene that includes at least one non-carbon atom (e.g. N, O, S, P or other heteroatom) in the backbone of the polymer or oligomer chain, and that does not have or include aromatic structures (e.g., aromatic rings) in the backbone of the polymer or oligomer chain. In some embodiments, non-aromatic heterohydrocarbylene groups are optionally substituted with various substituents, or functional groups, including but not limited to: halides, alkoxy groups, hydroxy groups, thiol groups, ester groups, ketone groups, carboxylic acid groups, amines, and amides. Heteroalkylene is an alkylene group having at least one non-carbon atom (e.g. N, O, S or other heteroatom) that, in some embodiments, is optionally substituted with various substituents, or functional groups, including but not limited to: halides, alkoxy groups, hydroxy groups, thiol groups, ester groups, ketone groups, carboxylic acid groups, amines, and amides. For the purpose of this disclosure, a “cycloalkyl” group is a saturated carbocyclic radical having three to twelve carbon atoms, preferably three to seven. A “cycloalkylene” group is an unsaturated carbocyclic radical having three to twelve carbon atoms, preferably three to seven. Cycloalkyl and cycloalkylene groups independently are monocyclic or polycyclic fused systems as long as no aromatics are included. Examples of carbocyclic radicals include cyclopropyl, cyclobutyl, cyclopentyl, cyclohexyl and cycloheptyl. In some embodiments, the groups herein are optionally substituted in one or more substitutable positions as would be known in the art. For example in some embodiments, cycloalkyl and cycloalkylene groups are optionally substituted with, among others, halides, alkoxy groups, hydroxy groups, thiol groups, ester groups, ketone groups, carboxylic acid groups, amines, and amides. In some embodiments, cycloalkyl and cycloalkene groups are optionally incorporated into combinations with other groups to form additional substituent groups, for example: “-Alkylene-cycloalkylene-, “-alkylene-cycloalkylene-alkylene-”, “-heteroalkylene-cycloalkylene-”, and “-heteroalkylene-cycloalkyl-heteroalkylene” which refer to various non-limiting combinations of alkyl, heteroalkyl, and cycloalkyl. These combinations include groups such as oxydialkylenes (e.g., diethylene glycol), groups derived from branched diols such as neopentyl glycol or derived from cyclo-hydrocarbylene diols such as Dow Chemical's UNOXOL® isomer mixture of 1,3- and 1,4-cyclohexanedimethanol, and other non-limiting groups, such -methylcylohexyl-, -methyl-cyclohexyl-methyl-, and the like. “Heterocycloalkyl” is one or more cyclic ring systems having 4 to 12 atoms and containing carbon atoms and at least one and up to four heteroatoms selected from nitrogen, oxygen, or sulfur. Heterocycloalkyl includes fused ring structures. Preferred heterocyclic groups contain two ring nitrogen atoms, such as piperazinyl. In some embodiments, the heterocycloalkyl groups herein are optionally substituted in one or more substitutable positions. For example in some embodiments, heterocycloalkyl groups are optionally substituted with halides, alkoxy groups, hydroxy groups, thiol groups, ester groups, ketone groups, carboxylic acid groups, amines, and amides.

Examples of MSA materials useful in the present invention are poly(ester-amides), poly(ether-amides), poly(ester-ureas), poly(ether-ureas), poly(ester-urethanes), and poly(ether-urethanes), and mixtures thereof that are described, with preparations thereof, in United States Patent Number (USPN) U.S. Pat. No. 6,172,167; and applicant's co-pending PCT application numbers PCT/US2006/023450, which was renumbered as PCT/US2006/004005 and published under PCT International Patent Application Number (PCT-IPAPN) WO 2007/099397; PCT/US2006/035201, which published under PCT-IPAPN WO 2007/030791; PCT/US08/053,917; PCT/US08/056,754; and PCT/US08/065,242. Preferred said MSA materials are described below.

In a set of preferred embodiments, the molecularly self-assembling material comprises ester repeat units of Formula I:

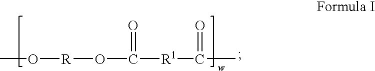

and at least one second repeat unit selected from the esteramide units of Formula II and III:

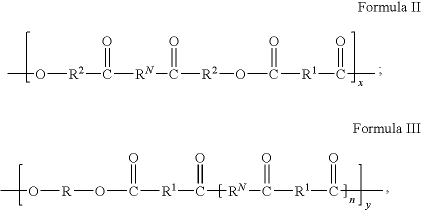

and the ester-urethane units of Formula IV:

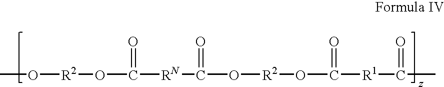

wherein

R is at each occurrence, independently a C₂-C₂₀ non-aromatic hydrocarbylene group, a C₂-C₂₀ non-aromatic heterohydrocarbylene group, or a polyalkylene oxide group having a group molecular weight of from about 100 to about 5000 g/mol. In preferred embodiments, the C₂-C₂₀ non-aromatic hydrocarbylene at each occurrence is independently specific groups: alkylene-, -cycloalkylene-, -alkylene-cycloalkylene-, -alkylene-cycloalkylene-alkylene-(including dimethylene cyclohexyl groups). Preferably, these aforementioned specific groups are from 2 to 12 carbon atoms, more preferably from 3 to 7 carbon atoms. The C₂-C₂₀ non-aromatic heterohydrocarbylene groups are at each occurrence, independently specifically groups, non-limiting examples including: -hetereoalkylene-,-heteroalkylene-cycloalkylene-, -cycloalkylene-heteroalkylene-, or -heteroalkylene-cycloalkylene-heteroalkylene-, each aforementioned specific group preferably comprising from 2 to 12 carbon atoms, more preferably from 3 to 7 carbon atoms. Preferred heteroalkylene groups include oxydialkylenes, for example diethylene glycol (—CH₂CH₂OCH₂CH₂—O—). When R is a polyalkylene oxide group it preferably is a polytetramethylene ether, polypropylene oxide, polyethylene oxide, or their combinations in random or block configuration wherein the molecular weight (Mn-average molecular weight, or conventional molecular weight) is preferably about 250 g/ml to 5000, g/mol, more preferably more than 280 g/mol, and still more preferably more than 500 g/mol, and is preferably less than 3000 g/mol; in some embodiments, mixed length alkylene oxides are included. Other preferred embodiments include species where R is the same C₂-C₆ alkylene group at each occurrence, and most preferably it is —(CH₂)₄—.

R¹ is at each occurrence, independently, a bond, or a C₁-C₂₀ non-aromatic hydrocarbylene group. In some preferred embodiments, R¹ is the same C₁-C₆ alkylene group at each occurrence, most preferably —(CH₂)₄—.

R² is at each occurrence, independently, a C₁-C₂₀ non-aromatic hydrocarbylene group. According to another embodiment, R² is the same at each occurrence, preferably C₁-C₆ alkylene, and even more preferably R² is —(CH₂)₂—, —(CH₂)₃—, —(CH₂)₄—, or —(CH₂)₅—.

R^{N} is at each occurrence —N(R³)—Ra—N(R³)—, where R³ is independently H or a C₁-C₆ alkyl, preferably C₁-C₄ alkyl, or R^{N} is a C₂-C₂₀ heterocycloalkylene group containing the two nitrogen atoms, wherein each nitrogen atom is bonded to a carbonyl group according to Formula II or III above; w represents the ester mol fraction, and x, y and z represent the amide or urethane mole fractions where w+x+y+z=1, 0<w<1, and at least one of x, y and z is greater than zero. Ra is a C₂-C₂₀ non-aromatic hydrocarbylene group, more preferably a C₂-C₁₂ alkylene: most preferred Ra groups are ethylene butylene, and hexylene —(CH₂)₆—. In some embodiments, R^{N} is piperazin-1,4-diyl. According to another embodiment, both R³ groups are hydrogen.

n is at least 1 and has a mean value less than 2.

In an alternative embodiment, the MSA is a polymer consisting of repeat units of either Formula II or Formula III, wherein R, R¹, R², R^{N}, and n are as defined above and x and y are mole fractions wherein x+y=1, and 0≦x≦1 and 0≦y≦1.

In certain embodiments comprising polyesteramides of Formula I and II, or Formula I, II, and III, particularly preferred materials are those wherein R is —(C₂-C₆)— alkylene, especially —(CH₂)₄—. Also preferred are materials wherein R¹ at each occurrence is the same and is C₁-C₆ alkylene, especially —(CH₂)₄—. Further preferred are materials wherein R² at each occurrence is the same and is —(C₁-C₆)— alkylene, especially —(CH₂)₅— alkylene. The polyesteramide according to this embodiment preferably has a number average molecular weight (Mn) of at least about 4000, and no more than about 20,000. More preferably, the molecular weight is no more than about 12,000.

For convenience the chemical repeat units for various embodiments are shown independently. The invention encompasses all possible distributions of the w, x, y, and z units in the copolymers, including randomly distributed w, x, y and z units, altenatingly distributed w, x, y and z units, as well as partially, and block or segmented copolymers, the definition of these kinds of copolymers being used in the conventional manner as known in the art. Additionally, there are no particular limitations in the invention on the fraction of the various units, provided that the copolymer contains at least one w and at least one x, y, or z unit. In some embodiments, the mole fraction of w to (x+y+z) units is between about 0.1:0.9 and about 0.9:0.1. In some preferred embodiments, the copolymer comprises at least 15 mole percent w units, at least 25 mole percent w units, or at least 50 mole percent w units.

In some embodiments, the number average molecular weight (Mₙ) of the MSA material useful in the present invention is between 1000 g/mol and 30,000 g/mol, inclusive. In some embodiments, Mₙ of the MSA material is between 2,000 g/mol and 20,000 g/mol, inclusive, preferably 5,000 g/mol to 12,000 g/mol. In more preferred embodiments, Mₙ of the MSA material is less than 5,000 g/mol. Thus, in some more preferred embodiments, Mₙ of the MSA material is at least about 1000 g/mol and 4,900 g/mol or less, more preferably 4,500 g/mol or less.

For preparing fibers comprising the MSA material useful in the present invention, viscosity of a melt of a preferred MSA material is characterized as being Newtonian over the frequency range of 10⁻¹ to 10² radians per second (rad./s.) at a temperature from above a melting temperature Tₘ up to about 40 degrees Celsius (° C.) above Tₘ, preferably as determined by differential scanning calorimetry (DSC). Depending upon the polymer or oligomer, preferred MSA materials exhibit Newtonian viscosity in the test range frequency at temperatures above 100° C., more preferably above 120° C. and more preferably still at or above 140° C. and preferably less than 300° C., more preferably less than 250° C. and more preferably still less than 200° C. For the purposes of the present disclosure, the term Newtonian has its conventional meaning; that is, approximately a constant viscosity with increasing (or decreasing) shear rate of a (MSA) material at a constant testing temperature. The MSA materials, preferably having Mₙ less than 5,000 g/mol, advantageously possess low melt viscosities useful for high output (relative to traditional high polymer extrusion) fiber melt blowing and utilities in submicron-fiber form. The zero shear viscosity of a preferred MSA material is in the range of from 0.1 Pa·s. to 1000 Pa·s., preferably from 0.1 Pa·s. to 100 Pa·s., more preferably from 0.1 to 30 Pa·s., still more preferred 0.1 Pa·s. to 10 Pa·s., between the temperature range of 180° C. and 220° C., e.g., 180° C. and 190° C.

Preferably, the viscosity of a melt of a MSA material useful in the present invention is less than 100 Pa·s. at from above Tₘ up to about 40° C. above Tₘ. The viscosity of one of the preferred MSA materials is less than 100 Pa·s. at 190° C., and more preferably in the range of from 1 Pa·s. to 50 Pa·s. at 150° C. to 170° C. Preferably, the glass transition temperature of the MSA material is less than 20° C. Preferably, the melting temperature is higher than 60° C. Preferred MSA materials exhibit multiple glass transition temperatures T_{g}. Preferably, the MSA material has a T_{g} that is higher than −80° C. Also preferably, the MSA material has a T_{g} that is higher than −60° C.

For preparing the fibers, especially by melt extrusion, the tensile modulus of one preferred group of MSA materials useful in the invention is preferably from 4 megapascals (MPa) to 500 MPa at room temperature, preferably 20° C. Tensile modulus testing is well known in the polymer arts.

Preferably, the torsional (dynamic) storage modulus of MSA materials useful in the invention is 12 MPa, more preferably at least 50 MPa, still more preferably at least 100 MPa, all at 20° C. Preferably, the storage modulus is 400 MPa or lower, more preferably 300 MPa or lower, still more preferably 250 MPa or lower, or still more preferably about 200 MPa or lower, all at 20° C.

Preferably, polydispersities of substantially linear MSA materials useful in the present invention is 4 or less, more preferably 3 or less, still more preferably 2.5 or less, still more preferably 2.2 or less.

In some embodiments, the polymers described herein are modified with, for example and without limitation thereto, one or more other polymers, resins, tackifiers, fillers, oils and additives (e.g. flame retardants, antioxidants, pigments, dyes, and the like).

### Extrusion Process of the First Embodiment

In some embodiments, the first rheological additive is essentially water in the extrusion process of the first embodiment and the extrusion temperature is below 100° C., the boiling point of water at 101 kPa (standard pressure). In such embodiments, preferably the extrusion process thereby produces a substantially defect-free extruded product comprising the MSA material without employing a decompression unit operation.

In some embodiments, the invention process of the first embodiment allows extrusion of a melt of a composition comprising an amorphous or semicrystalline MSA material and the first rheological additive at a temperature that is just above (e.g., from 1° C. to 60° C. above) the amorphous or semicrystalline MSA material's (highest) T_{g} or Tₘ, respectively. In other embodiments, the extrusion temperature is at or slightly below (e.g., 10° C. to 1° C. below) the T_{g} or Tₘ, more preferably from about 90° C. to about 130° C., still more preferably from about 90° C. to less than 100° C., even more preferably from about 95° C. to about 99° C. In other embodiments, the invention extrusion process of the first embodiment facilitates, without stretching, polymer chain alignment, orientation, and crystallization to improve the MSA material's physical properties (e.g., increase melting temperature) and performance properties (e.g., increase tensile modulus and elongation to break). Combinations of the aforementioned embodiments are also contemplated.

Preferably, the invention process of the first embodiment further comprises a mixing step before the extruding step, the mixing step comprising mixably contacting the first rheological additive to the MSA material to give the composition useful in the process of the first embodiment. In some embodiments, the mixing step is performed with the MSA material at a temperature of about 25° C. or higher, and preferably less than about 100° C., and, if necessary, may further comprise a step of heating the composition to give the melt thereof. Where the first rheological additive is an inorganic salt or an organic salt essentially lacking water (i.e., not in the form of an aqueous solution, the composition is formed by first dissolving the MSA material in a water-miscible organic solvent such as methanol or ethanol to give a solution, and then mixably contacting the solution to water to precipitate a mixture comprising the MSA material and the inorganic salt or an organic salt, and drying the precipitated mixture to remove the organic solvent therefrom and, optionally, removing the water therefrom, to give the composition useful in the process of the first embodiment. Preferably, the organic solvent is warmed above 25° C., up to its boiling point if necessary, to effect dissolution of the MSA material therein.

In some embodiments, the shaped MSA material produced by the process of the first embodiment is used directly (i.e., without further processing such as cooling or removing rheological additive) in a subsequent process such as fabricating an article comprising the shaped MSA material and one or more other components. In other embodiments, the process of the first embodiment further comprises a subsequent cooling step, removing step, or a combination thereof.

The subsequent removing step is especially preferred when the composition useful in the process of the first embodiment contains water and lacks the inorganic salt and an organic salt. Where the first rheological additive comprises water and one or more of the inorganic salt, organic salt, inorganic acid, and inorganic base, the subsequent removing steps comprise: (a) removing at least 90 percent of the one or more inorganic salt, organic salt, inorganic acid, and inorganic base from the shaped MSA material (e.g., by washing the shaped MSA material with water); (b) removing at least 90 percent of the water from the shaped MSA material; or both. Where the first rheological additive comprises water without any of the inorganic salt, organic salt, inorganic acid, and inorganic base, the subsequent removing step comprises the same as for above step (b). Methods of removing water from the shaped MSA material include evaporating, blotting, wiping, and phase-separating water from the shaped MSA material. Examples of evaporating are air drying, drying under vacuum, freeze drying, and blow drying. Examples of blotting and wiping are contacting a water-absorbent material to the shaped MSA material, allowing the water-absorbent material to absorb water off of the shaped MSA material, and separating the water-absorbent material from the resulting blotted or wiped shaped MSA material. An example of phase-separating water from the shaped MSA material is cooling the shaped MSA material to above 0° C. to give a liquid phase containing mostly water and a solid phase containing mostly the MSA material, and separating the liquid phase from the solid phase (e.g., by spinning, rolling, wiping, or blotting the solid phase). The removing step optionally may include heating such as, for example, by applying infrared radiation, heated air, heated rollers (e.g., calendaring), heated substrate (e.g., a substrate layer in a laminate comprising the shaped MSA material in the form of a sheet and the substrate layer), or a combination thereof to the shaped MSA material.

The subsequent cooling step comprises cooling the shaped MSA material to a lower temperature, for example, from a hot temperature (e.g., 95° C.) to a warm temperature (e.g., 50° C.), ambient temperature (e.g., 25° C.), or lower. The term “cooling” means lowering temperature by at least 5° C. and includes passive cooling (employing ambient conditions) and active cooling (employing a cooling unit operation).

The extrusion process of the first embodiment comprises preparing any class of extruded thermoplastic product. Preferably, the extrusion process of the first embodiment comprises depositing a film or sheet, fabricating a fiber, forming a hose, forming tubing, casting a part, or molding a part. In some embodiments, the extruded fiber, sheet, hose, or tubing is further processed by stretching to produce a drawn fiber, sheet, hose, or tubing, which typically is thinner than the extruded fiber, sheet, hose, or tubing. Preferably, the fibers comprising the MSA material are fabricated substantially without defects such as bubbles or fractures.

Methods of extruding thermoplastic materials to produce films, sheets, fibers, hoses, tubing, cast parts, or molded parts therefrom are generally known. These methods are readily adaptable for extruding the composition according to the process of the first embodiment. By way of illustration, a description of extruding fibers comprising the MSA materials follows here.

### Fabricating Fibers Comprising the MSA Materials by Melt Spinning Extrusion

In a typical melt spinning extrusion process for fabricating fibers comprising an MSA material useful in the present invention, the melt of the composition comprising MSA material and a rheological additive is performed on a Werner & Pfleiderer ZSK-25-4 extruder.

The parameters for operating the extruder for effective melt spinning extrusion of the composition useful in the present invention may be readily determined by a person of ordinary skill in the art without undue experimentation. By way of example, the barrel zone (Z1 to Z10) temperature set points are chosen as 50 (Z1) to 110 (Z10)° C., die temperature 130° C., screw speed 125 revolutions per minute (rpm).

Use of commercially available plastic extruders such as manufactured by Werner & Pfleiderer, Battenfeld, Collin, Reifenhauser are more preferred.

Melt spun extruded fibers of the present invention (e.g., produced using a capillary rheometer comprising a die defining a 0.5 mm or 1.0 mm hole) typically have an average diameter of from about 100 micrometers (μm) to about 1000 μm. In some embodiments, the extruded fibers have an average diameter of from about 150 μm to about 500 μm (i.e., from about 0.15 mm to about 0.5 mm). Melt spun extruded fibers that are further subjected to stretching produce drawn fibers having an average diameter of from about 100 μm to about 500 μm.

### Fabricating Fibers Comprising the MSA Material by Melt Blowing Extrusion

A melt blowing device typically comprises at least one die block having a portion that functions as a die tip; at least one gas knife assembly; a source of a stretch gas stream; and a collector, wherein the source of a stretch gas stream independently is in operative fluid communication with the gas knife assembly and the die tip. The die tip defines at least one, preferably a plurality of, apertures through which a melt of a material to be melt blown passes. A source of the melt is in operative fluid communication with the apertures of the die tip. Examples of useful stretch gases are air, nitrogen, argon, helium, and a mixture of any two or more thereof. Preferably, the stretch gas is air, nitrogen, or a mixture thereof; more preferably the stretch gas is air. An example of a melt blowing device is an Oerlikon Neumag Meltblown Technology™ system (Oerlikon Heberlein Wattwil AG, Switzerland). Preferably, the stretch gas is air sourced from a compressed air chamber and temperature of the stretch gas is measured in the compressed air chamber.

The invention herein may use any melt blowing system but preferably uses specialized process melt-blowing systems produced by Hills, Inc. of West Melbourne, Fla. 32904. See e.g. U.S. Pat. No. 6,833,104 B2, and WO 2007/121458 A2 the teachings of each of which are hereby incorporated by reference. See also www.hillsinc.net/technology.shtml and www.hillsinc.net/nanomeltblownfabric.shtml and the article “Potential of Polymeric Nanofibers for Nonwovens and Medical Applications” by Dr John Hagewood J. Hagewood, LLC, and Ben Shuler, Hills, Inc, published in the 26 Feb. 2008 Volume of Fiberjournal.com. Preferred dies have very large Length/Diameter flow channel ratios (L/D) in the range of greater than 20/1 to 1000/1, preferably greater than 100/1 to 1000/1, including for example, but not limited to, L/D values 150/1, 200/1, 250/1, 300/1 and the like so long as there is sufficient polymer back pressure for even polymer flow distribution. Additionally, the die spinholes (“holes”) are typically on the order of 0.05 to 0.2 mm in diameter.

Melt blown extruded fibers of the present invention typically have an average diameter of from about 0.5 μm to about 5 μm.

### Fabricating Fibers Comprising the MSA Materials Useful in the Present Invention by Melt Electroblowing Extrusion

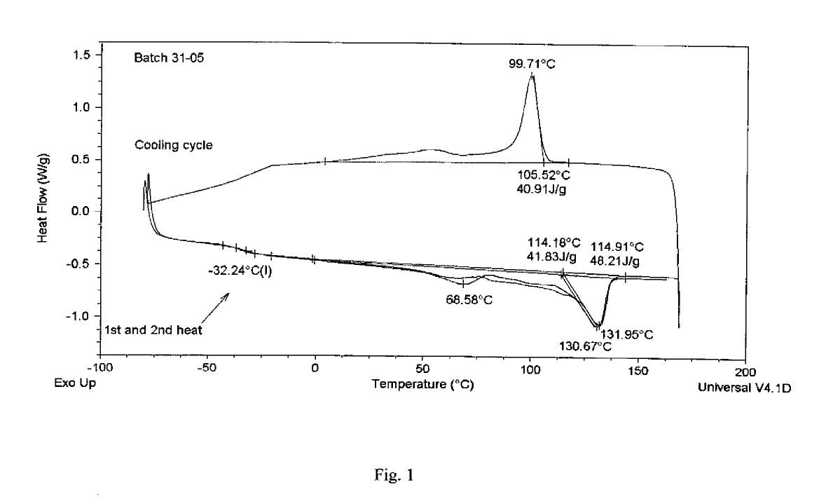

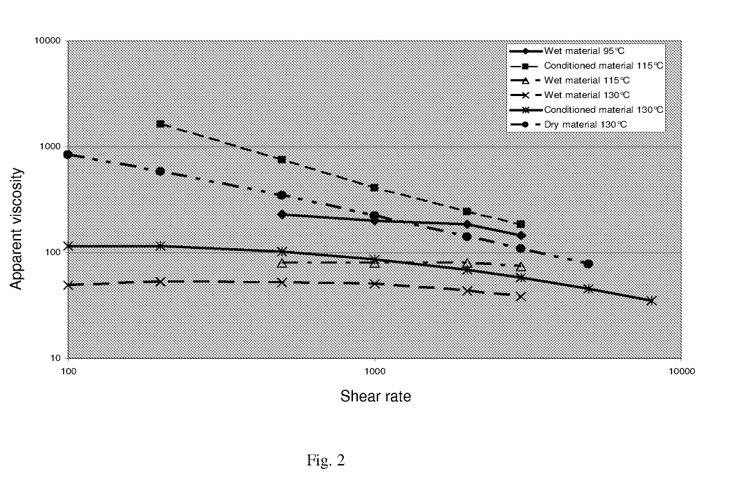

Some melt electroblowing process embodiments of the first aspect of the present invention employ the melt electroblowing apparatus and process that are described in U.S. Patent Application Publication Number US 2005/0067732 A1, including FIGS. 1, 2a, and 2b thereof. In such an embodiment, the melt electroblowing process of the present invention comprises feeding a stream of the melt of the composition employed in the process of the first embodiment or the composition of the fourth embodiment (or simply the “instant melt”) from a storage tank (e.g., 100 in FIG. 1 of US 2005/0067732 A1) to a spinning nozzle, a “die” (e.g., 104 in FIG. 1 of US 2005/0067732 A1), within a spinneret (e.g., 102 in FIG. 2a of US 2005/0067732 A1) to which a voltage differential is applied and through which the instant melt is discharged. Meanwhile, compressed gas, optionally heated in gas heater (e.g., 108 in FIG. 1 of US 2005/0067732 A1), is issued from gas knives (e.g., 106 in FIG. 1 of US 2005/0067732 A1) disposed in the sides, the periphery, or other geometry of spinning nozzle (e.g., 104 in FIG. 1 of US 2005/0067732 A1). The gas is used as a blowing gas stream which envelopes and forwards the instant melt and aids in the formation of an instant shaped MSA material as a fibrous web by stretching the forming fibers that are collected on a grounded/biased collector some distance from the spinneret. Preferably the collector is a porous collection belt (e.g., 110 in FIG. 1 of US 2005/0067732 A1) that is disposed some distance from a vacuum chamber (e.g., 114 in FIG. 1 of US 2005/0067732 A1), which has vacuum applied from the inlet of gas blower (e.g., 112 in FIG. 1 of US 2005/0067732 A1). The gas nozzle (e.g., 106 in FIG. 1 of US 2005/0067732 A1) is disposed on a knife edge at both sides of the spinning nozzle (e.g., 104 in FIG. 1 of US 2005/0067732 A1). In the spinning nozzle (e.g., 104 in FIG. 1 of US 2005/0067732 A1), the instant melt flows under pressure into the spinning nozzle (e.g., 104 in FIG. 1 of US 2005/0067732 A1) through an upper portion thereof and is injected past a capillary tube in the lower end. In other embodiments, preferably a number of such spinning nozzles (e.g., 104 in FIG. 1 of US 2005/0067732 A1) are arranged in a line or matrix for a given interval and a number of gas knife (e.g., 106 in FIG. 1 of US 2005/0067732 A1) are arranged having knife edges at both sides of the spinning nozzles (e.g., 104 in FIG. 1 of US 2005/0067732 A1) parallel to the line or matrix thereof, such that a fiber may be spun. Preferably, the gas knives (e.g., 106 in FIG. 1 of US 2005/0067732 A1) each have a gap sized so that adequate gas is available and in adequate volume to forward a fiber exiting from the spinneret as would be determinable for one skilled in the art. The lower end die/spinneret/capillary tube has a diameter (e.g., d in FIG. 2b of US 2005/0067732 A1) which preferably are sized so as to optimize the fiber diameter, typically in the range of about 0.01 millimeter to about 2.0 millimeter and preferably about 0.1 millimeter to 1.0 millimeter. The lower end capillary tube of the gas nozzle (e.g., 106 in FIG. 2b of US 2005/0067732 A1) has a ratio of length (e.g., L in FIG. 2b of US 2005/0067732 A1) to the diameter (e.g., d in FIG. 2b of US 2005/0067732 A1), also referred to as L/d, which is in the range of about 1/5 to about 1/1000, preferably about 1/20 to 1/500 and more preferably 1/50 to 1/250. In some embodiments of the present invention, a nozzle projection distance (e.g., e in FIG. 2a of US 2005/0067732 A1) functions to prevent pollution of the spinning nozzle (e.g., 104 in FIG. 2a of US 2005/0067732 A1).

Located a distance below the spinneret (e.g., 102 in FIG. 2a of US 2005/0067732 A1) is a collector (e.g., 110 in FIG. 1 of US 2005/0067732 A1) for collecting the instant shaped MSA material as a fibrous web. A preferred collector comprises a moving belt or screen (e.g., 110 in FIG. 1 of US 2005/0067732 A1) on which the fibrous web is collected. The collector preferably includes a porous fibrous scrim, preferably comprised of a useful, typical material such as low density polyethylene and/or polypropylene, polyester or polyamide scrim as would typically be known and used in the art. The scrim preferably is placed onto the moving belt, whereupon the fibrous web is formed. The belt (e.g., 110 in FIG. 1 of US 2005/0067732 A1) is advantageously made from a porous material such as a metal or polymer screen so that a vacuum preferably is drawn from opposite the belt through vacuum chamber (e.g., 114 in FIG. 1 of US 2005/0067732 A1) from the inlet of blower (e.g., 112 in FIG. 1 of US 2005/0067732 A1). The collection belt is preferably grounded oppositely in charge as the spinneret so as to attract charged instant melt of the MSA-containing composition. The spin-draw ratio (the relative rate of material being forced from the spinneret compared to the rate of the fiber being pulled/drawn out) for the invention melt electroblowing process depends on many variables that can be used to change the properties, such as the diameter of the shaped MSA material that is a fiber. The variables include the charge density of the fluid, viscosity, the gaseous flow rate and the electrostatic potentials (for example, a secondary electrode preferably is implemented to manipulate the flow of the jet stream of the instant melt of the composition containing MSA material). Some of these variables may be alterable during processing. The method further provides for the concomitant co-spinning of charged and non-charged instant melts from the same die assembly to prepare composite fibers. In some embodiments, the temperature of the gaseous flow is used to change the viscosity of the spinning instant melt(s). The draw forces increasing with increasing gaseous flow rate and applied electrostatic potentials. In some embodiments, the balance between the two driving forces (electrostatic field and gaseous flow field) is expanded further by a substantial increase in the gaseous flow rate with a practical limit of the velocity of sound, and the charge density of the fluid.

In some melt electroblowing process embodiments of the first aspect of the present invention, melt discharge pressure preferably is in the range of about 0.01 kilograms per square centimeter (kg/cm²) to about 200 kg/cm², more preferably in the range of about 0.1 kg/cm² to about 20 kg/cm². In other embodiments, melt throughput per spinhole (also referred to as spinneret hole or capillary), e.g. melt flow rate per spinhole, preferably is in the range of about 0.01 grams per minute (g/min) to about 50 g/min, more preferably about 0.05 g/min to about 25.0 g/min, still more preferably about 0.1 g/min to 20 g/min, and even more preferably 0.75 g/min to about 10 g/min.

In some melt electroblowing process embodiments of the first aspect of the present invention, temperature of the instant melt preferably is from room temperature (e.g., about 25° C.) to about 300° C. More preferably, the melt temperature is from room temperature to about 200° C. and still more preferably from about 95° C. and about 130° C.

In some melt electroblowing process embodiments of the first aspect of the present invention, temperature of the blow or stretch gas preferably is from 0° C. to 300° C., more preferably 25° C. to 200° C., and still more preferably 40° C. to 150° C. In other embodiments, flow rate of blow or stretch gas preferably is from about 0 standard cubic feet per hour (SCFH) to 300 SCFH, more preferably from 10 SCFH to 250 SCFH, still more preferably from 30 SCFH to 150 SCFH. In some melt electroblowing process embodiments of the first aspect of the present invention, velocity of the compressed blowing gas preferably is between about 10 meters/minute (m/min) and about 20,000 m/min, and more preferably between about 100 m/min and about 3,000 m/min Blowing gas preferably are compressed air, nitrogen, inert gas such as argon and the like or mixtures of gases such as nitrogen and compressed gas to control any degradation of the MSA that might occur.

In some melt electroblowing process embodiments of the first aspect of the present invention, voltage differential (e.g. the electric field) between the electrode and the spinneret preferably is in the range of about 0.1 kilovolts (kV) to about 200 kV, more preferably in the range of 1.0 kV to 150 kV, still more preferably 10 kV to 60 kV, even more preferably from 60 kV to 120 kilovolts, and yet more preferably from 1 kV to 40 kV. One of skill in the art can establish the required voltage for a given fiber. The voltage differential includes positive and negative polarities with respect to the ground potential or a biased voltage differential. For example in some embodiments, the voltage differential of about X kV is based on electrodes having +0.5X kV to −0.5X kV, wherein X is a numerical voltage differential. In other embodiments, other electro-biasing field controlling sources of voltage are applied, as would be know in the art, to control or contain the electroblown fibers within the apparatus so that the fibers are collected at a collector.

In some melt electroblowing process embodiments of the first aspect of the present invention, distance between the spinneret and the collector surface (also referred to as the “die to collector distance” or “DCD” or “electrode distance”) preferably is in the range of about 1 cm to about 500 cm, more preferably in the range of about 5 cm to about 100 cm and still more preferably in the range of about 10 cm to 50 cm.

Melt electroblown extruded fibers of the present invention typically have an average diameter of from about 0.5 μm to about 5 μm.

### Fabricating Fibers Comprising MSA Materials by Melt Electrospinning Process of the Fifth Embodiment

Whereas the extrusion process of the first embodiment comprises preparing any class of extruded thermoplastic product such as, for example, a class selected from the group consisting of: a film or sheet, fabricating a fiber, forming a hose, forming tubing, casting a part, and molding a part, the melt electrospinning process of the fifth embodiment comprises fabricating a fiber comprising a MSA material.

The melt electrospinning process of the fifth embodiment preferably is carried out by employing the second rheological additive with the melt electrospinning process as described in PCT International Patent Application Publication Number WO 2008/101051. For example, in a typical melt electrospinning process, the melt of the second composition of the fourth embodiment is fed into or onto a spinneret from, for example, a syringe at a constant and controlled rate using a metering pump. A high voltage (e.g., 1 kV to 120 kV) is applied and the drop of composition at the nozzle of the syringe becomes highly electrified. At a characteristic voltage the droplet forms a Taylor cone, and a fine jet of the second composition of the fourth embodiment develops. The fine jet is drawn to a conductor (e.g., a grounded conductor), which is placed opposite the spinneret. While being drawn to the conductor, the jet cools and hardens into one or more fibers of the sixth embodiment. Preferably, the fibers are deposited on a collector that is placed in front of the conductor. In some embodiments, the fibers are deposited on the collector as a randomly oriented, nonwoven mat or individually captured and wound-up on a roll. The fibers are subsequently stripped from the collector if desired. In other embodiments, a charged conductor (opposite polarity to that of electrode) is employed instead of the grounded conductor.

The parameters for operating the electrospinning apparatus for effective melt spinning of the melt of the second composition of the fourth embodiment are readily determined by a person of ordinary skill in the art without undue experimentation. By way of example, the spinneret is generally heated up to about 300° C., the spin electrode temperature is maintained at about 10° C. or higher (e.g., up to just below a decomposition temperature of the composition or up to about 150° C. higher) above the melting point or temperature at which the melt of the second composition of the fourth embodiment has sufficiently low viscosity to allow thin fiber formation, and the surrounding environmental temperature is unregulated or, optionally, heated (e.g., maintained at about similar temperatures using hot air). Alternatively, the spinneret is generally heated up to about 300° C. and the surrounding environmental temperature optionally is maintained at about room temperature (i.e., from about 20° C. to 30° C.). The applied voltage is generally about 1 kV to 120 kV, preferably 1 kV to 80 kV. The electrode gap (the gap between spin electrode and collector) is generally between about 3 cm and about 50 cm, preferably about 3 cm and about 19 cm. Preferably, the fibers are fabricated at about ambient pressure (e.g., 1.0 atmosphere) although the pressure may be higher or lower.

Preferred electrospinning devices are those that are marketed commercially as being useful for melt electrospinning. Use of commercially available melt electrospinning devices, such as those available from NanoStatics™, LLC, Circleville, Ohio, USA; and Elmarco s.r.o., Liberec, Czech Republic (e.g., using Nanospider™ technology), are preferred.

Melt electrospun fibers of the sixth embodiment typically have an average diameter of from about 100 nanometers (nm) to about 1000 nm. A melt electrospinning process described above preferably produces the fibers of the sixth embodiment without beading.

### Methods

### Average Fiber Diameter

For purposes of the present invention, average fiber diameter for a plurality of fibers is determined by processing a scanning electron microscope (SEM) image thereof with, for example, a QWin image analysis system (Leica Microsystems GmbH, 35578 Wezlar, Germany).

Procedure for Determining Number Average Molecular Weight (Mₙ) of a MSA Material by nuclear magnetic resonance spectroscopy

Carbon-13 nuclear magnetic resonance (¹³C-NMR) or, preferably, proton nuclear magnetic resonance spectroscopy (proton NMR or ¹H-NMR) is used to determine monomer purity, MSA copolymer composition, and MSA copolymer number average molecular weight Mₙ utilizing the CH₂OH end groups. Proton NMR assignments are dependent on the specific structure being analyzed as well as the solvent, concentration, and temperatures utilized for measurement. For ester amide monomers and co-polyesteramides, d4-acetic acid is a convenient solvent and is the solvent used unless otherwise noted. For ester amide monomers of the type called DD that are methyl esters typical peak assignments are about 3.6 to 3.7 ppm for C(═O)—OCH₃; about 3.2 to 3.3 ppm for N—CH₂—; about 2.2 to 2.4 ppm for C(═O)—CH₂—; and about 1.2 to 1.7 ppm for C—CH₂—C. For co-polyesteramides that are based on DD with 1,4-butanediol, typical peak assignments are about 4.1 to 4.2 ppm for C(═O)—OCH₂—; about 3.2 to 3.4 ppm for N—CH₂—; about 2.2 to 2.5 ppm for C(═O)—CH₂—; about 1.2 to 1.8 ppm for C—CH₂—C, and about 3.6 to 3.75 —CH₂OH end groups.

### X-Ray Fluorescence (XRF) PROCEDURE

Grind a sample of a composition comprising a MSA material and inorganic salt with liquid nitrogen to a powder, place a weighed amount of powder in a P1 cup, press, and measure amount of the inorganic salt in the composition by x-ray fluorescence (XRF) spectrophotometry of the ground sample using, for example, a PW1606 x-ray fluorescence spectrophotometer (Koninklijke Philips Electronics N.V., Amsterdam, Netherlands) with UNIQUANT™ software (Thermo Fisher Scientific Incorporated, Waltham, Mass., USA).

### Compression Molding Procedure:

Prior to molding, all samples are allowed to dry overnight (at least 16 hours) at 65° C. in a vacuum of approximately 36 cmHg (48 kiloPascals (kPa)). Samples are compression molded into 10 cm×10 cm×0.05 cm plaques and 5 cm×1.25 cm×0.32 cm bars using a MPT-14 compression/lamination press (Tetrahedron Associates, Inc., San Diego, Calif., USA). The molding parameters for composites comprising the MSA materials are listed in Table 1.

TABLE 1
Summary of compression molding parameters
for composites comprising the MSA material

| | | | | | Load ramp | |
|---|---|---|---|---|---|---|
| | Temper- | Temperature | | | rate, | |
| | ature | ramp rate | Load, kg | | kg/minute | Time |
| Step | (° C.) | (° C./minute) | (klb) | | (klb/min) | (minutes) |
| 1 | 140 | 93 | 608 | (1.5) | 317 × 10³ | 5 |
| | | | | | (1200) | |
| 2 | 140 | 93 | 4536 | (10) | 317 × 10³ | 4 |
| | | | | | (1200) | |
| 3 | 140 | 93 | 18143 | (40) | 317 × 10³ | 3 |
| | | | | | (1200) | |
| 4 | 37.8 | 93 | 450 | (1) | 317 × 10³ | 5 |
| | | | | | (1200) | |
| 5 | End | | | | | |

### Dynamic Mechanical Spectroscopy (DMS) Procedure

Prior to conducting DMS experiments, all samples are exposed to laboratory atmosphere for at least 40 hours to allow for sample equilibration to the test environment. Samples are in the form of the 5 cm×1.25 cm×0.32 cm compression molded bars, which are loaded into torsional rectangular holders of an Ares Rheometer from TA Instruments. Initially, a dynamic strain sweep is conducted at 1 Hz and 25° C. beginning at a strain of 0.001%. For each sample a strain value is obtained from a region where storage modulus (G′) is linear over a range of strain values. This strain value is used for subsequent dynamic frequency sweeps and dynamic temperature ramps. Using the strain value obtained during the strain sweep, a frequency sweep is conducted at 25° C. The frequency ranged from 100 radians per second (rad/s.) to 0.01 rad/s. Finally, a temperature ramp is conducted from −80° C. to 100° C. at a heating rate of 5° C./minute. The frequency is held constant at 1 Hz. Plot results as storage modulus, G′, in Pascals (Pa) versus temperature (° C.).

### Preparations

### Preparation 1: preparation of MSA material that is a polyesteramide (PEA) comprising 50 mole percent of ethylene-N,N′-dihydroxyhexanamide (C2C) monomer (the MSA material is generally designated as a PEA-C2C50%)

### Step (a) Preparation of the diamide diol monomer, ethylene-N,N′-dihydroxyhexanamide (C2C)

a 10-Liter (L) Stainless Steel Reactor Equipped with an Agitator and a cooling water jacket is charged with ε-caprolactone (5.707 kilograms (kg), 50 moles) and purged with nitrogen. Under rapid stirring, ethylene diamine (EDA; 1.502 kg, 25 moles) is added at once. After an induction period a slow exothermic reaction starts. The reactor temperature gradually rises to 90° C. under maximum cooling applied. A white deposit forms and the reactor contents solidify, at which point stirring is stopped. The reactor contents are then cooled to 20° C. and are then allowed to rest for 15 hours. The reactor contents are then heated to 140° C. (at which temperature the solidified reactor contents melt), and heated then further to 160° C. under continued stirring for at least 2 hours. The resulting liquid product is then discharged from the reactor into a collecting tray. A nuclear magnetic resonance study of the resulting product shows that the molar concentration of C2C in the product exceeds 80 percent. The procedure is repeated four more times resulting in five product lots. The melting temperature of the product is determined to be 130-140° C. (main melting temperature) by differential scanning calorimetry (DSC) (peak maximum). The solid material is granulated and used without further purification.

### Step (b): Preparation of PEA-C2C50% Material of Preparation 1

A 2.5 L, single-shaft kneader/devolatizer reactor equipped with distillation column, feed cylinders and vacuum pump system is charged at room temperature or 50° C. to 60° C. with 0.871 kg of dimethyl adipate (DMA) and 0.721 kg of C2C (granulated, of step (a)), under a nitrogen atmosphere. The reactor temperature is slowly brought to 140° C. to 150° C. under nitrogen purge to obtain a clear solution. Then, still under nitrogen and at 140° C. to 150° C., 0.419 kg of 1,4-butanediol (1,4-BD) is loaded from the Feed cylinder 1 into the reactor, and the resulting mixture is homogenized by continued stirring at 140° C. Subsequently, titanium(IV) tetrabutoxide catalyst is injected from Feed cylinder 2 as 34.84 gram of a 10% by weight solution in 1,4-BD (4000 ppm calculated on DMA; 3.484 g catalyst+31.36 g 1,4-BD; total content of 1,4-BD is 0.450 kg). Methanol starts distilling and the kneader temperature is increased stepwise to 180° C. over a period of 2 to 3 hours at atmospheric pressure. Methanol fraction is distilled off and collected (theoretical amount: 0.320 kg) in a cooling trap. When the major fraction of methanol is removed, the kneader pressure is stepwise decreased first to 50 mbar to 20 mbar, and then further to 5 mbar to complete the methanol removal and to initiate distillation of 1,4-BD. The pressure is further decreased to less than 1 mbar or as low as possible, until a slow-but-steady distillation of 1,4-butanediol is observed (calculated theoretical amount 0.225 kg) and the distillation is continued for 10 hours. During this operation the temperature is raised to 190° C. to 200° C. at maximum as to avoid discoloration. When the 1,4-butanediol removal is completed, the kneader is cooled to about 150° C. and brought to atmospheric pressure under nitrogen blanket and the material is collected and allowed to solidify. After cooling, the PEA-C2C50% material of Preparation 1 is milled to granules. Melt viscosity of the PEA-C2C50% material of Preparation 1 is 30,000 mPa·s at 180° C. Viscosities are determined using a Brookfield DV-II+Vicosimeter with spindle number 28 at 20 revolutions per minute (rpm).

The polymer glass transition and melting temperatures (Tg and Tm) are determined by DSC (peak maximum) to be −32° C. and 130° C., respectively. The polymer melting temperature is determined by DSC (peak maximum). The DSC trace is shown in FIG. 1.

Analysis data for PEA-C2C50% material of Preparation 1 are shown below in Table 2.

TABLE 2

| | Melt viscosity* | Melting temperature |
|---|---|---|
| Polymer | (mPa · s) at180° C. | (° C.) by DSC |
| PEA-C2C50 % material | 30,000 | 130 |
| of Preparation 1 | | |

*Brookfield DV-II+ Vicosimeter with spindle number 28 at 20 rpm

Physical properties obtained from compression molded plaques are presented in Table 3.

TABLE 3

| | Storage | Ultimate | Percent |
|---|---|---|---|
| | Modulus | Tensile | Elongation to |
| Polymer | (G′) (MPa) | Strength (MPa) | break (%) |
| PEA-C2C50 % material | 200 | 30 | 700 |
| of Preparation 1 | | | |

Rheological properties of the PEA-C2C50% material are characterized on a TA Instruments Ares II system.

### Preparation 2: Dried PEA-C2C50% Material

Dry a sample of some of the PEA-C2C50% material of Preparation 1 in a vacuum oven at 60° C. and 1 millibar ((mbar; 0.1 kiloPascals (kPa)) to 20 mbar (2 kPa) pressure for a minimum of 24 hours to give the dried PEA-C2C50% material.

### Preparation 3: Another Preparation of PEA-C2C50% Material

In a manner similar to the procedure described above for Preparation 1, prepare another PEA-C2C40% material except as follows.

### Step (b): Preparation of PEA-C2C50% Material of Preparation 3

Use a 120 L kneader-devolatizer reactor (LIST) instead of the 2.5 L, single-shaft kneader/devolatizer reactor in Preparation 1. Preheat the 120 L reactor to 120° C. to 140° C.) and charge it with 38.324 kg (220 moles) of DMA (liquid), 31.724 kg (110 moles) of C2C (solid), and 18.436 kg of 1,4-BD with nitrogen blanket. Slowly bring temperature of the 120 L reactor to 140° C. to 150° C. under nitrogen purge to obtain a clear solution. Subsequently, at about 145° C., charge the 120 L reactor with titanium(IV)tetrabutoxide (1533 gram of a 10% by weight solution in 1,4-BD; 4000 ppm calculated on DMA) with continued stirring. Methanol starts distilling. Distill methanol fraction off and collect condensed methanol (theoretical amount: 14.1 Kg, 440 moles) in a cooled drum. When a major fraction of methanol has been removed at 180° C., discharge the condensed methanol and decrease pressure in the 120 L reactor stepwise from 100 mbar in 5 minutes to 50 mbar to 20 mbar and further to 5 mbar to complete removal of methanol and initiate distillation of the 1,4-BD. Discharge any distilled and condensed liquid. Further decrease the pressure to less than 1 mbar, or as low as possible, until observing a steady distillation of 1,4-BD. Raise the 120 L reactor temperature to 200° C., and then finally to 210° C. Collect 9.9 kg of 1,4-BD (110 moles). Towards the end of the 1,4-BD distillation (stripping), check viscosity of the residual melt at regular intervals; the target melt viscosity is 8,000±500 mPa·s at 180° C.; reaction time 30 hours. Bring the 120 L reactor to atmospheric pressure under nitrogen blanket, and discharge the residual polymer to a stripe granulation line to give PEA-C2C50% material. Produce pellets of the PEA-C2C50% material. Melting point and melt viscosity data for PEA-C2C50% material of Preparation 3 are shown below in Table 4.

TABLE 4

| | Melt viscosity* | Melting point |
|---|---|---|
| Polymer | (mPa · s) at180° C. | (° C.) by DSC |
| PEA-C2C50 % material | 8,370 | 122 |
| of Preparation 3 | | |

*Brookfield DV-II+ Vicosimeter with spindle number 28 at 20 rpm

### Preparation 4: Dried PEA-C2C50% Material

Dry a sample of some of the PEA-C2C50% material of Preparation 3 in a vacuum oven at 60° C. and 1 millibar ((mbar; 0.1 kiloPascals (kPa)) to 20 mbar (2 kPa) pressure for a minimum of 24 hours to give the dried PEA-C2C50% material.

### COMPARATIVE EXAMPLE(S)

### Comparative Example 1

### A Fiber Comprising the Dried PEA-C2C50% Material of Preparation 2

Extrude a fiber from a melt of a sample of the dried PEA-C2C50% material of Preparation 4 using a Gottfert Rheograph 6000 (triple bore system) having a die with a length of 30 millimeters (mm) and an inner diameter of 0.5 mm, a chamber, and piston, wherein the melt, chamber, die, and piston are at the same temperature. Feed a sample of the resulting dried PEA-C2C50% material into the Gottfert Rheograph 600. Wait for from 5 minutes to 10 minutes for the sample to melt and come to an initial sample melt temperature of 125° C. Record the initial temperature of the melt. Begin extruding a fiber from the melt to give the fiber of Comparative Example 1. Record pressure drop and calculate viscosity in a given shear rate region for the experiment.

### EXAMPLES OF THE PRESENT INVENTION

### Example 1

### Humidified PEA-C2C50% Material

Humidify a sample of the PEA-C2C50% material of Preparation 1 by exposing the sample to Deutsches Institut für Normung e. V. (DIN) standard conditions of 23° C. and 50% relative humidity to give the humidified PEA-C2C50% material of Example 1.

### Example 2

### Hydrated PEA-C2C50% Material

Hydrate a sample of the PEA-C2C50% material of Preparation 1 by contacting the sample to excess water for 24 hours to give the hydrated PEA-C2C50% material of Example 2. Determine water content of the hydrated PEA-C2C50% material to be 4.7 wt % by Karl Fischer titration method.

### Examples 3A1 to 3A3 and 3B1 to 3B4

### Fibers Comprising the Humidified PEA-C2C50% Material of Example 1 and Hydrated PEA-C2C50% Material of Example 2, Respectively

Separately repeat the procedure of Comparative Example 1 four times, except use the humidified PEA-C2C50% material of Example 1 instead of the dried PEA-C2C50% material of Preparation 4, a die having an inner diameter of 1.0 mm instead of 0.5 mm, and an initial sample melt temperature of 130° C., 130° C., 115° C., or 95° C. instead of 125° C., to separately give the fibers of Examples 3A1 (130° C., 0), 3A2 (130° C.), and 3A3 (115° C.), respectively. The humidified PEA-C2C50% material of Example 1 is not processable at 95° C. and did not produce a fiber. Separately repeat the procedure of Comparative Example 1 four times, except use the hydrated PEA-C2C50% material of Example 2 instead of the dried PEA-C2C50% material of Preparation 4, a die having an inner diameter of 1.0 mm instead of 0.5 mm, and an initial sample melt temperature of 130° C., 115° C., 95° C., or 95° C. instead of 125° C., to separately give the fibers of Examples 3B1 (130° C.), 3B2 (115° C.), 3B3 (95° C.), and 3B4 (95° C.), respectively. Record pressure drop and calculate viscosity in a given shear rate region for the experiment.

### Example 4

### Composition Consisting Essentially of Magnesium Nitrate (Mg(NO₃)₂) and PEA-C2C50% Material

Dissolve a sample of some of the PEA-C2C50% material of Preparation 1 in warmed ethanol to give an ethanol solution thereof. Add the ethanol solution to a 1.0 molar (M) aqueous Mg(NO₃)₂ solution, and dry the resulting precipitated material in a vacuum oven at 60° C. and 0.1 kPa to 2 kPa pressure for a minimum of 24 hours to give the composition of Example 4 consisting essentially of Mg(NO₃)₂ and PEA-C2C50% material.

### Example 5

### Composition Consisting Essentially of Ammonium Sulfate ((NH₄)₂SO₄) and PEA-C2C50% Material

Repeat the procedure described in Example 4 except use a 1.0 M aqueous (NH₄)₂SO₄ solution instead of the 1.0 M aqueous Mg(NO₃)₂ solution to give the composition of Example 5 consisting essentially of (NH₄)₂SO₄ and PEA-C2C50% material.

### Example 6

### Composition Consisting Essentially of Sodium Chloride (NaCl) and PEA-C2C50% Material

Repeat the procedure of Example 4, except use a 1.0 M aqueous NaCl solution instead of the 1.0 M aqueous Mg(NO₃)₂ solution, to give the composition of Example 6 consisting essentially of NaCl and PEA-C2C50% material.

### Example 7

### Composition Consisting Essentially of Mg(NO₃)₂ and PEA-C2C50% Material

Repeat the procedure of Example 4, except use the PEA-C2C50% material of Preparation 3 instead of the PEA-C2C50% material Preparation 1 and a 0.5 M aqueous Mg(NO₃)₂ solution instead of the 1.0 M aqueous Mg(NO₃)₂ solution, to give the composition consisting essentially of Mg(NO₃)₂ and PEA-C2C50% material. The composition of Example 7 contains 0.676 wt % of magnesium by XRF, which translates to the composition containing 4.13 wt % of Mg(NO₃)₂.

### Example 8

### Composition Consisting Essentially of (NH₄)₂SO₄ and PEA-C2C50% Material

Repeat the procedure described in Example 4, except use the PEA-C2C50% material of Preparation 3 instead of the PEA-C2C50% material Preparation 1 and a 0.5 M aqueous (NH₄)₂SO₄ solution instead of the 1.0 M aqueous Mg(NO₃)₂ solution to give the composition of Example 8 consisting essentially of (NH₄)₂SO₄ and PEA-C2C50% material. The composition of Example 8 contains 0.823 wt % of sulfur by XRF, which translates to the composition containing 3.39 wt % of (NH₄)₂SO₄.

### Example 9

### Composition Consisting Essentially of NaCl and PEA-C2C50% Material

Repeat the procedure of Example 4, except use the PEA-C2C50% material of Preparation 3 instead of the PEA-C2C50% material of Preparation 1 and a 0.5 M aqueous NaCl solution instead of the 1.0 M aqueous Mg(NO₃)₂ solution, to give the composition of Example 9 consisting essentially of NaCl and PEA-C2C50% material. The composition of Example 9 contains 2.43 wt % of chlorine by XRF, which translates to the composition containing 4.86 wt % of NaCl.

### Examples 10A, 10B, and 10C

### Extrusion of Fibers of the Compositions of Examples 4, 5, and 6, Respectively

Separately repeat the extrusion procedure of Example 3A1 three times with the compositions of Examples 4, 5, or 6 instead of the humidified PEA-C2C50% material of Example 1 to respectively give the fibers of Examples 10A, 10B, and 10C.

### Examples 11A, 11B, and 11C

### Extrusion of Fibers of the Compositions of Examples 7, 8 and 9

Separately repeat the procedure of Comparative Example 1 three times, except use the compositions of Examples 7, 8, or 9 to respectively give the fibers of Examples 11A, 11B, and 11C consisting essentially of Mg(NO₃)₂, (NH₄)₂SO₄, or NaCl, respectively, and PEA-C2C50% material.

### Examples 12A, 12B, and 12C

### Compositions Consisting Essentially of Mg(NO₃)₂, (NH₄)₂SO₄, or NaCl, Respectively, and PEA-C2C50% Material

Separately repeat the procedure described in Example 4 three times, except use the PEA-C2C50% material of Preparation 3 instead of the PEA-C2C50% material of Preparation 1 and a 0.05 M aqueous Mg(NO₃)₂ solution, 0.05 M aqueous (NH₄)₂SO₄ solution, or 0.05 M aqueous NaCl solution instead of the 1.0 M aqueous Mg(NO₃)₂ solution to respectively give the compositions of Examples 12A, 12B, and 12C consisting essentially of Mg(NO₃)₂, (NH₄)₂SO₄, or NaCl, respectively, and PEA-C2C50% material. The compositions of Examples 12A, 12B, and 12C respectively contain 0.144 wt % of magnesium, 0.175 wt % of sulfur, and 0.335 wt % of chlorine by XRF, which respectively translates to the compositions of Examples 12A, 12B, and 12C containing 0.88 wt % of Mg(NO₃)₂, 0.72 wt % of (NH₄)₂SO₄, and 0.55 wt % of NaCl.

### Examples 13A, 13B, and 13C

### Extrusion of Fibers of a Composition Consisting Essentially of Mg(NO₃)₂, (NH₄)₂SO₄, or NaCl, Respectively, and PEA-C2C50% Material

Separately repeat the procedure of Comparative Example 1 three times, except use the composition of Examples 12A, 12B, or 12C to respectively give the fibers of Examples 13A, 13B, and 13C consisting essentially of Mg(NO₃)₂, (NH₄)₂SO₄, or NaCl, respectively, and PEA-C2C50% material.

### Examples 14A, 14B, 14C, 14D, 14E and 14F

### Water-Washed Compositions Prepared By Water-Washing Penultimate Compositions Consisting Essentially of Mg(NO₃)₂, (NH₄)₂SO₄, or NaCl, Respectively, and PEA-C2C50% Material

Separately place a 10 g sample of each of the compositions of Examples 7, 8, 9, 12A, 12B, or 12C in 250 mL of water, and allow it to sit for about 16 hours. Rinse the resulting water-wet sample four times with 100 mL water each time, and dry in a vacuum oven at 60° C. and 1 mbar (0.1 kPa) to 20 mbar (2 kPa) pressure for a minimum of 24 hours to respectively give the water-washed compositions of Examples 14A, 14B, 14C, 14D, 14E and 14F.

### Examples 15A, 15B, 15C, 15D, 15E and 15F

### Extrusion of Fibers of Water-Washed Compositions

Separately repeat the procedure of Comparative Example 1 six times, except use the water-washed composition of Examples 14A, 14B, 14C, 14D, 14E or 14F to respectively give the fibers of Examples 15A, 15B, 15C, 15D, 15E and 15F.

### Viscosity and Shear Rate Analysis

Plot apparent viscosity versus shear rate for each of the dried PEA-C2C50% material of Preparation 2, humidified PEA-C2C50% material of Example 1, and hydrated PEA-C2C50% material of Example 2 as illustrated in FIG. 2. As shown in FIG. 2, the influence of water on the viscosity is considerable. In this experiment, the dried PEA-C2C50% material of Preparation 2 is processed at an initial sample melt temperature of 130° C., as it is difficult to measure pressure drop at an initial sample melt temperature below 130° C. because, in the absence of a rheological additive, the dried PEA-C2C50% material of Preparation 2 solidifies at or below about 130° C. and thereby blocks the die. The humidified PEA-C2C50% material of Example 1 is separately extruded at initial sample melt temperatures of 130° C. (which gives an extrusion temperature of 120° C.) and 115° C., but extrusion below an initial sample melt temperature of 115° C. is difficult because its viscosity is too high for satisfactory extrusion. The hydrated PEA-C2C50% material of Example 2 is processed even at an initial sample melt temperature of 95° C. (which gives an extrusion temperature of 90° C.). The apparent viscosity of the hydrated PEA-C2C50% material of Example 2 at initial sample melt temperature of 95° C. is almost the same as the apparent viscosity of the dried PEA-C2C50% material of Preparation 2 at initial sample melt temperature of 130° C.

### DSC Analysis

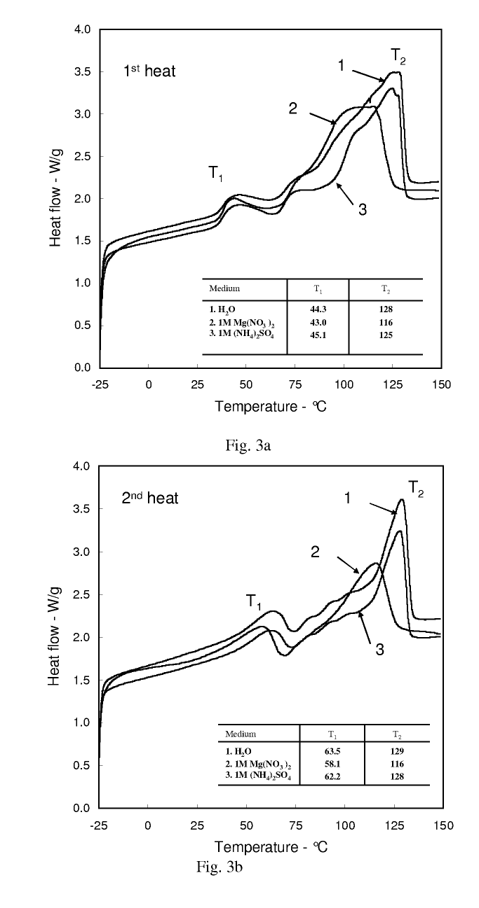

Perform DSC (from −25° C. to 150° C. at 10° C. per minute) on the material of Example 2 and the compositions of Examples 4 and 5, and record the resulting DSC traces as heat flow (W/g) versus temperature (° C.). Overlay the DSC traces as shown in FIGS. 3a and 3b. The DSC traces in FIGS. 3a and 3b generally show that melting and crystallization temperatures, and hence organization and crystallinity, of a PEA-C2C50% material, are influenced by the presence of an inorganic salt essentially in the absence of water. In this particular case the influence is more pronounced with Mg(NO₃)₂ than with (NH₄)₂SO₄.

### Tensile Strength Testing

Separately cut fibers produced in Comparative Example 1 and Examples 3A1, 3A2, 3B3, 3B4, 13A, 13B, 13C, 15A, 15B, 15C, 15D, 15E, and 15F to 50 millimeters (mm) testing lengths and measure tensile strengths with an Instron 5565 load frame equipped with a Instron series IX Automated Materials Tester software computer control and data acquisition and analysis system (Instron Corporation, Canton, Mass., USA) and a load cell of 0.1 kiloNewtons (kN). Use a data acquisition rate (sample rate) of 10 data points per second (pts/s) and a crosshead speed of 200 millimeters per minute (mm/min). Record extrusion temperature (° C.), extrusion shear in reciprocal seconds (s⁻¹), tensile speed in millimeters per minute (mm/min), ultimate tensile strength in megaPascals (MPa), and percent elongation to break (%) in tabular form as shown below in Table 5.

TABLE 5
fiber process conditions and fiber strength

| | | | | Ultimate | Percent |
|---|---|---|---|---|---|
| | Extrusion | | Tensile | tensile | Elongation |
| (Test Sample*) | Temperature | Shear | Speed | strength | to break |
| Fiber Sample | (° C.) | (s⁻¹) | (mm/min) | (MPa) | (%) |
| (Preparation 4) | 125 | 1000 | 200 | 21.1 | 690 |
| Comparative | | | | | |
| Example 1 | | | | | |
| (Example 1) | 120 | 720 | 200 | 25.4 | 1140 |
| Example 3A1 | | | | | |
| (Example 1) | 120 | 720 | 100 | 21.0 | 900 |
| Example 3A2 | | | | | |
| (Example 2) | 90 | 400 | 100 | 22.0 | 1200 |
| Example 3B3 | | | | | |
| (Example 2) | 90 | 400 | 200 | 24.7 | 1070 |
| Example 3B4 | | | | | |
| (Example 12A) | 120 | 1000 | 200 | 22.7 | 747 |
| Example 13A | | | | | |
| (Example 12B) | 125 | 1000 | 200 | 23.3 | 707 |
| Example 13B | | | | | |
| (Example 12C) | 125 | 1000 | 200 | 24.8 | 716 |
| Example 13C | | | | | |
| (Example 14A) | 115 | 1000 | 200 | 18.2 | 724 |
| Example 15A | | | | | |
| (Example 14B) | 125 | 1000 | 200 | 21.8 | 929 |
| Example 15B | | | | | |
| (Example 14C) | 125 | 1000 | 200 | 22.5 | 952 |
| Example 15C | | | | | |
| (Example 14D) | 125 | 1000 | 200 | 22.3 | 918 |
| Example 15D | | | | | |
| (Example 14E) | 125 | 1000 | 200 | 15.4 | 773 |
| Example 15E | | | | | |
| (Example 14F) | 125 | 1000 | 200 | 23.9 | 970 |
| Example 15F | | | | | |

*Test sample indicates the material or composition used to prepare the Fiber.

Data in Table 5 show, among other things, that water mediated extrusion is performed on the hydrated PEA-C2C50% material of Example 2 at an extrusion temperature that is 30° C. below the extrusion temperature of the humidified PEA-C2C50% material of Example 1. As shown by comparing ultimate tensile strength and percent elongation to break data in Table 5 for the hydrated PEA-C2C50% material of Example 2 to the corresponding data for the humidified PEA-C2C50% material of Example 1, the physical properties (tensile-elongation) of the fibers extruded from the hydrated PEA-C2C50% material of Example 2 are at least equal to the physical properties of fibers extruded from the humidified PEA-C2C50% material of Example 1.

Also, data in Table 5 show, among other things, that salt mediated extrusion of fibers performed on the PEA-C2C50% materials of Example 12 and 14 is feasible at similar conditions than dried PEA-C2C50% material of Preparation 4. As shown by comparing the Example 13 and Example 15 ultimate tensile strength and percent elongation to break data in Table 5 to the corresponding data of Comparative Example 1 in the same table, the physical properties (tensile-elongation) of the fibers extruded from the salt modified PEA-C2C50% material of Example 12 and 14 are at least equal, and significantly superior in the case of an additional washing step of the material, to the physical properties of fibers extruded from the dried PEA-C2C50% material of Preparation 4.

While the invention has been described above according to its preferred embodiments of the present invention and examples of steps and elements thereof, it may be modified within the spirit and scope of this disclosure. This application is therefore intended to cover any variations, uses, or adaptations of the instant invention using the general principles disclosed herein. Further, this application is intended to cover such departures from the present disclosure as come within the known or customary practice in the art to which this invention pertains and which fall within the limits of the following claims.

1. A process for extruding a molecularly self-assembling material, the process comprising a step of extruding a melt of a composition comprising a molecularly self-assembling (MSA) material and a first rheological additive to produce a shaped MSA material, wherein the first rheological additive comprises a total of from 0.5 weight percent to 10 weight percent of the composition, the extruding step excludes electrospinning, and the first rheological additive comprises an inorganic salt, organic salt, water, an aqueous solution of an inorganic or organic salt, or an aqueous solution of an inorganic acid or inorganic base.

2. The process as in claim 1, the process further comprising a step of removing at least 90 percent of the first rheological additive from the shaped MSA material.

3. (canceled)

4. (canceled)

5. The process as in claim 1, wherein the molecularly self-assembling material is a polyester-amide, polyether-amide, polyester-urethane, polyether-urethane, polyether-urea, polyester-urea, or a mixture thereof.

6. The process as in claim 1, wherein the MSA material comprises self-assembling units comprising multiple hydrogen bonding arrays

7.-9. (canceled)

10. The process as in claim 1, wherein the molecularly self-assembling material comprises repeat units of formula I: 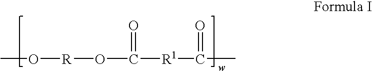
and at least one second repeat unit selected from the ester-amide units of Formula II and III: 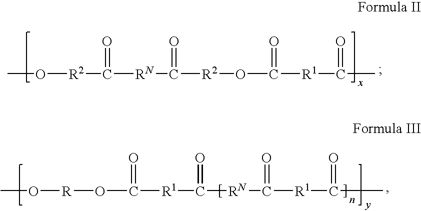
and the ester-urethane units of Formula IV: 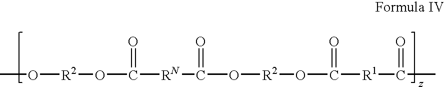
or combinations thereof wherein:
R is at each occurrence, independently a C₂-C₂₀ non-aromatic hydrocarbylene group, a C₂-C₂₀ non-aromatic heterohydrocarbylene group, or a polyalkylene oxide group having a group molecular weight of from about 100 grams per mole to about 5000 grams per mole;
R¹ at each occurrence independently is a bond or a C₁-C₂₀ non-aromatic hydrocarbylene group;
R² at each occurrence independently is a C₁-C₂₀ non-aromatic hydrocarbylene group;
R^{N} is —N(R³)—Ra—N(R³)—, where R³ at each occurrence independently is H or a C₁-C₆ alkylene and Ra is a C₂-C₂₀ non-aromatic hydrocarbylene group, or R^{N} is a C₂-C₂₀ heterocycloalkyl group containing the two nitrogen atoms, wherein each nitrogen atom is bonded to a carbonyl group according to formula (III) above;
n is at least 1 and has a mean value less than 2; and
w represents the ester mol fraction of Formula I, and x, y and z represent the amide or urethane mole fractions of Formulas II, III, and IV, respectively, where w+x+y+z=1, and 0<w<1, and at least one of x, y and z is greater than zero but less than 1.

11. The process as in claim 1, wherein the MSA material is of Formula II or III: 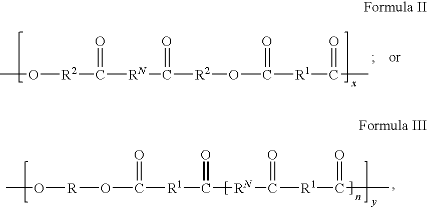
wherein:
R is at each occurrence, independently a C₂-C₂₀ non-aromatic hydrocarbylene group, a C₂-C₂₀ non-aromatic heterohydrocarbylene group, or a polyalkylene oxide group having a group molecular weight of from about 100 grams per mole to about 5000 grams per mole;
R¹ at each occurrence independently is a bond or a C₁-C₂₀ non-aromatic hydrocarbylene group;
R² at each occurrence independently is a C₁-C₂₀ non-aromatic hydrocarbylene group;
R^{N} is —N(R³)—Ra—N(R³)—, where R³ at each occurrence independently is H or a C₁-C₆ alkylene and Ra is a C₂-C₂₀ non-aromatic hydrocarbylene group, or R^{N} is a C₂-C₂₀ heterocycloalkyl group containing the two nitrogen atoms, wherein each nitrogen atom is bonded to a carbonyl group according to formula (III) above;
n is at least 1 and has a mean value less than 2; and
x and y represent mole fraction wherein x+y=1, and 0≦x≦1, and 0≦y≦1.

12. The process as in claim 1, wherein the number average molecular weight (Mn) of the molecularly self-assembling material is between about 1000 grams per mole and about 50,000 grams per mole.

13.-20. (canceled)

21. The process as in claim 1, wherein the shaped MSA material comprises one or more fibers having an average diameter of from about 0.010 micrometers (μm) to about 30 μm.

22. (canceled)

23. The process as in claim 1, wherein the first rheological additive essentially is water.

24. The process as in claim 1, wherein the first rheological additive comprises the aqueous solution of the inorganic acid or inorganic base.

25. The process as in claim 1, wherein the first rheological additive comprises the inorganic salt or the aqueous solution of the inorganic salt.

26. (canceled)

27. The process as in claim 25, wherein the inorganic acid or inorganic salt comprises an inorganic anion that is fluoride (F—), sulfate (SO₄²⁻), hydrogen sulfate (HSO₄⁻), thiosulfate (S₂O₃²⁻), hydrogen thiosulfate (HS₂O₃⁻), phosphate (PO₄³⁻), hydrogen phosphate (HPO₄²⁻), dihydrogen phosphate (H₂PO₄⁻), chloride (Cl⁻), nitrate (NO₃⁻), bromide (Br⁻), iodide (I⁻), or perchlorate (ClO₄⁻).

28. The process as in claim 25, wherein the inorganic base or inorganic salt comprises an inorganic cation that is ammonium (NH₄⁺), potassium cation (K⁺), sodium cation (Na⁺), lithium cation (Li⁺), magnesium cation (Mg²⁺), or calcium cation (Ca²⁺).

29. (canceled)

30. The process as in claim 1, wherein the first rheological additive comprises the organic salt or the aqueous solution of the organic salt.

31. (canceled)

32. The process as in claim 30, wherein the organic salt comprises an organic anion that is carbonate (CO₃²⁻), acetate (CH₃CO₂⁻), or thiocyanate (SCN⁻) or an organic cation that is tetramethylammonium (N(CH₃)₄⁺) or guanidinium (C(NH₂)₃⁺).

33. (canceled)

34. The process as in claim 1, wherein the melt of the composition is characterized as having a viscosity that is less than a viscosity of a melt consisting essentially of the molecularly self-assembling material, wherein each viscosity is determined at a temperature that is the higher of 10 degrees Celsius above glass transition temperature (T_{g}) or above melting temperature (Tₘ) of the molecularly self-assembling material without any first rheological additive.

35. (canceled)

36. The process as in claim 1, wherein the melt of the composition is extruded at a temperature of from 90 degrees Celsius to 130 degrees Celsius.

37. The process as in claim 1, the process comprising melt spinning, melt blowing, or melt electroblowing.

38. A composition comprising a molecularly self-assembling material and a second rheological additive, wherein the second rheological additive comprises a total of from 0.5 weight percent (wt %) to 10 wt % of the composition; and the second rheological additive comprises an inorganic salt, an organic salt, an aqueous solution of the inorganic or organic salt, an aqueous solution of an inorganic acid, or an aqueous solution of an inorganic base, wherein the inorganic salt comprises an anion that is fluoride (F⁻), sulfate (SO₄²⁻), hydrogen sulfate (HSO₄⁻), thiosulfate (S₂O₃²⁻), phosphate (PO₄³⁻), hydrogen phosphate (HPO₄²⁻), dihydrogen phosphate (H₂PO₄⁻), chloride (Cl⁻), nitrate (NO₃⁻), bromide (Br⁻), iodide (I⁻), or perchlorate (ClO₄⁻); a cation that is ammonium (NH₄⁺), potassium cation (K⁺), sodium cation (Na⁺), lithium cation (Li⁺), magnesium cation (Mg²⁺), or calcium cation (Ca²⁺); or at least one of the foregoing anions and at least one of the foregoing cations; and the organic salt has from 1 to 3 carbon atoms.

39. (canceled)

40. A process for melt electrospinning a fiber comprising a MSA material, the process comprising steps of: feeding a melt of the composition as in claim 38 into a melt electrospinning device; and applying a voltage to the device such that the composition is drawn and a jet is formed to produce a fiber comprising the MSA material.

41. (canceled)
